(19) United States
(12) Patent Application Publication
(10) Pub. No.: US 2025/0219777 A1
(43) Pub. Date: Jul. 3, 2025

(54) SENSING RESOURCE DETECTION WITH INTERFERENCE SELF-AWARENESS

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 18/850,032

(22) PCT Filed: Jun. 3, 2022
(86) PCT No.: PCT/CN2022/097022

§ 371 Date: Sep. 23, 2024

(51) Int. Cl. H04L 5/00

(52) U.S. Cl. CPC H04L 5/0048; H04L 5/0073

(57) ABSTRACT

Radio frequency (RF) sensing by a sensing node, such as a user equipment (UE) or base station, in a wireless network is supported preconfiguring a sensing resource set by a network node and sending the preconfigured resource set for sensing to the sensing node. The sensing node measures interference on the resources of the preconfigured resource set before selecting and occupying one or more resources for sensing. The interference may be measured based on signal strength measurements and one or more interference thresholds, which may be provided to the sensing node by the network node. Reports based on the interference of the resources may be provided by the sensing node to the network node with which the network node may configure sensing resource sets for other sensing nodes or may reconfigure the sensing resource set for the sensing node if no resources in the current preconfigured resource set are available.

### BACKGROUND

### Field

Subject matter disclosed herein relates generally to wireless communication, and more specifically, to radio frequency sensing in a wireless communication system.

### Information

Radar is a ranging technique that can be used to determine the distances of objects relative to a given location. A radar system operates by transmitting and receiving electromagnetic pulses. Some of the pulses reflect off objects or surfaces along the transmission path, producing “echoes.” The radar system may determine the distances of the objects or surfaces based on a round trip time between the transmission of a pulse to the reception of an echo of that pulse.

In a mono-static radar system, the antennas used to transmit the pulses (“transmit antennas”) are collocated with the antennas used to receive the echoes (“receive antennas”). For example, the transmit antennas and receive antennas are often disposed on the same device. This allows for simple synchronization between the timing of the transmitted pulses and the timing of the received echoes since the same device (or system) clock may be used for both. In a multi-static radar system, the transmit antennas are located a substantial distance away from the receive antennas. The spatial diversity afforded by multi-static radar systems provides a high accuracy of target location and allows different aspects of a target to be viewed simultaneously.

Radio frequency (RF) sensing is a technique, similar to (and may include) radar, that can be used to determine one or more of the presence, location, identity, or combination thereof of objects. RF sensing, for example, may be used in wireless communication systems, such as cellular communications system (5G and 5G beyond). With a large bandwidth allocated to, e.g., 5G and 5G beyond, cellular communications system RF sensing may be considered a critical feature in future cellular systems. Improvements for RF sensing are desired.

### SUMMARY

Radio frequency (RF) sensing by a sensing node, such as a user equipment (UE) or base station, in a wireless network is supported preconfiguring a sensing resource set by a network node and sending the preconfigured resource set for sensing to the sensing node. The sensing node measures interference on the resources of the preconfigured resource set before selecting and occupying one or more resources for sensing. The interference may be measured based on signal strength measurements and one or more interference thresholds, which may be provided to the sensing node by the network node. Reports based on the interference of the resources may be provided by the sensing node to the network node with which the network node may configure sensing resource sets for other sensing nodes or may reconfigure the sensing resource set for the sensing node if no resources in the current preconfigured resource set are available.

In one implementation, a method performed by a sensing node in a wireless network for supporting radio frequency (RF) sensing in the wireless network includes receiving from a network node a preconfigured resource set for sensing; selecting one or more resources from the preconfigured resource set for sensing; and transmitting the one or more resources for sensing.

In one implementation, a sensing node in a wireless network configured for supporting radio frequency (RF) sensing in the wireless network, includes at least one wireless transceiver; at least one memory; and at least one processor coupled to the at least one wireless transceiver and the at least one memory, wherein the at least one processor is configured to cause the network node to: receive, via the at least one wireless transceiver, from a network node a preconfigured resource set for sensing; select one or more resources from the preconfigured resource set for sensing; and transmit, via the at least one wireless transceiver, the one or more resources for sensing.

In one implementation, a sensing node in a wireless network configured for supporting radio frequency (RF) sensing in the wireless network, includes means for receiving from a network node a preconfigured resource set for sensing; means for selecting one or more resources from the preconfigured resource set for sensing; and means for transmitting the one or more resources for sensing.

In one implementation, a non-transitory storage medium including program code stored thereon, the program code is operable to configure at least one processor in a sensing node in a wireless network for supporting radio frequency (RF) sensing in the wireless network, the program code comprising instructions to: receive from a network node a preconfigured resource set for sensing; select one or more resources from the preconfigured resource set for sensing; and transmit the one or more resources for sensing.

In one implementation, a method performed by a network node in a wireless network for supporting radio frequency (RF) sensing by a sensing node in the wireless network includes receiving a capability message from the sensing node with sensing capabilities of the sensing node; generating a preconfigured resource set for sensing based on the sensing capabilities of the sensing node; and sending the preconfigured resource set for sensing to the sensing node enabling the sensing node to select one or more resources from the preconfigured resource set for sensing.

In one implementation, a network node in a wireless network configured for supporting radio frequency (RF) sensing by a sensing node in the wireless network, includes an external interface; at least one memory; and at least one processor coupled to the external interface and the at least one memory, wherein the at least one processor is configured to cause the network node to: receive, via the external interface, a capability message from the sensing node with sensing capabilities of the sensing node; generate a preconfigured resource set for sensing based on the sensing capabilities of the sensing node; and send, via the external interface, the preconfigured resource set for sensing to the sensing node enabling the sensing node to select one or more resources from the preconfigured resource set for sensing.

In one implementation, a network node in a wireless network configured for supporting radio frequency (RF) sensing by a sensing node in the wireless network, includes means for receiving a capability message from the sensing node with sensing capabilities of the sensing node; means for generating a preconfigured resource set for sensing based on the sensing capabilities of the sensing node; and means for sending the preconfigured resource set for sensing to the sensing node enabling the sensing node to select one or more resources from the preconfigured resource set for sensing.

In one implementation, a non-transitory storage medium including program code stored thereon, the program code is operable to configure at least one processor in a network node in a wireless network for supporting radio frequency (RF) sensing by a sensing node in the wireless network, the program code comprising instructions to: receive a capability message from the sensing node with sensing capabilities of the sensing node; generate a preconfigured resource set for sensing based on the sensing capabilities of the sensing node; and send the preconfigured resource set for sensing to the sensing node enabling the sensing node to select one or more resources from the preconfigured resource set for sensing.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to various aspects of the disclosure.

FIG. 2 shows an example of a bi-static sensing system.

FIGS. 3A, 3B, and 3C illustrate examples of wireless systems with shared or separate communication and sensing signals.

FIG. 4A illustrates cross link interference (CLI) in communication signals.

FIGS. 4B and 4C illustrate CLI in different wireless environments.

FIGS. 5A, 5B, and 5C illustrate example sensing systems in which CLI may occur.

FIG. 6 illustrates a message flow between a sensing node and a network node for supporting RF sensing using a preconfigured resource set for sensing.

FIG. 7 illustrates a process of sensing resource determination using interference detection.

FIGS. 8A-8D illustrate message flows between a sensing node and a network node for supporting RF sensing using interference reports.

FIG. 9 illustrates a message flow between a sensing node and network node for supporting RF sensing using a time window.

FIG. 10 illustrates a schematic block diagram showing certain exemplary features of a sensor node that supports sensing using a preconfigured resource set in a wireless network.

FIG. 11 illustrates a schematic block diagram showing certain exemplary features of a network node that supports sensing using a preconfigured resource set in a wireless network.

FIG. 12 illustrates a flowchart for an exemplary process for supporting radio frequency (RF) sensing in a wireless network using a preconfigured resource set for sensing.

FIG. 13 illustrates a flowchart for an exemplary process for supporting RF sensing in a wireless network using a preconfigured resource set for sensing.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on. UEs may be embodied by any of a number of types of devices including but not limited to printed circuit (PC) cards, compact flash devices, external or internal modems, wireless or wireline phones, smartphones, tablets, consumer asset tracking devices, asset tags, and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). A communication link through which a UE signals to another UE is called a sidelink (SL) or sidelink channel. As used herein, the term traffic channel (TCH) can refer to either an UL/reverse, DL/forward, or SL traffic channel.

The term “base station” may refer to a single physical transmission-reception point (TRP), which may also be referred to as a transmit/receive point, or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring.

Radio frequency (RF) sensing is a technique, similar to (and may include) radar, that can be used to determine one or more of the presence, location, identity, or combination thereof of objects in the environment. RF sensing, for example, may be used to image the environment, based on one or more of range, Doppler, and angle information. The use of RF signals with higher frequencies, larger bandwidths, or transmission/reception from a compact array may provide better granularity for sensing the environment, which may be applicable to a mobile device or AP for sensing.

By way of example, a handheld radar device becomes promising in applications such as gesture classification and in-car-based control etc. In a handheld radar device, a sensing chip may send the RF (radar) signals with pre-defined waveform, e.g., frequency modulated continuous wave (FMCW) and pulse. The reflected signals (Rx) from an object, such as the user's hand, are received and correlated with the transmitted signals Tx from which one or more of the range, Doppler, angle information may be determined. The object and/or motions of the object may be classified and mapped to designed actions.

Integrated Sensing and Communication (ISAC) technologies are another example of the use of RF (radar) signals to sense the environment. ISAC seeks to enable the combination of the sensing and communication systems to utilize resources efficiently and even to pursue mutual benefits. ISAC is of intertest to the 3rd Generation Partnership Project (3GPP), which is standardization body for mobile telecommunications, to explore the sensing functions in the legacy communication structures. By way of example, some companies propose to enable the work in Service and System Aspects (SA), where the sensing resource is configured by the network, and coexists with data transmission.

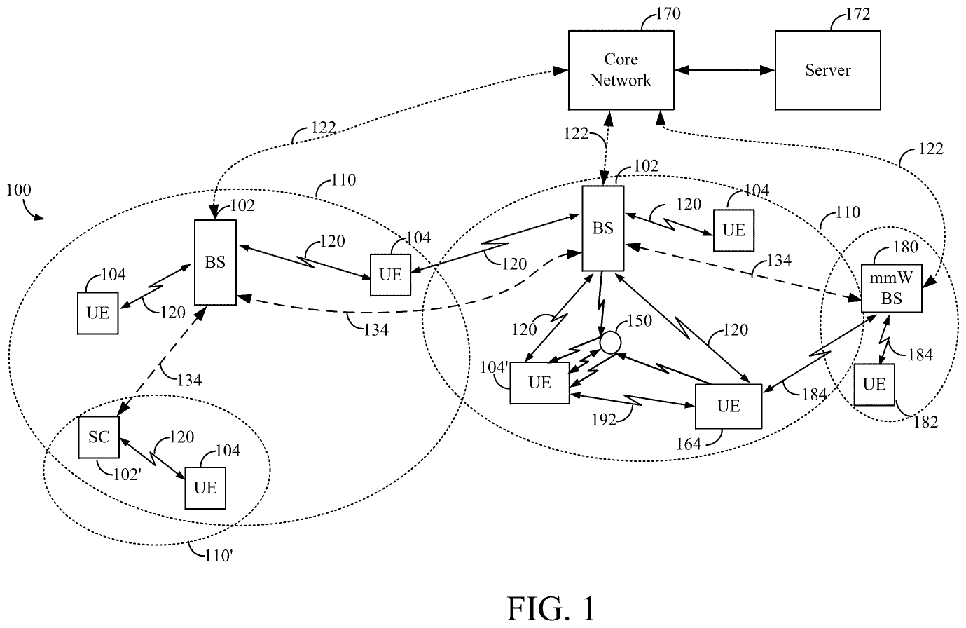

FIG. 1 illustrates an example wireless communications system 100. The wireless communications system 100 (which may also be referred to as a wireless wide area network (WWAN) or a wireless network (e.g., a cellular network) may include various base stations 102, sometimes referred to herein as gNBs 102 or other types of NBs, and various UEs 104. The base stations 102 may include macro cell base stations (high power wireless base stations) and/or small cell base stations (low power wireless base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more sensing servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by a WLAN AP. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs that connects indirectly to one or more communication networks via one or more device-to-device (D2D) peer-to-peer (P2P) links. In the example of FIG. 1, UE 164 has a D2D P2P link 192 with one of the UEs 104 connected to one of the base stations 102. Link 192 may be used to indirectly obtain wireless connectivity or for D2D communications between UEs 104 and 164 without use of the base station 102. In some implementations, the link 192 is a sidelink (SL) between the UEs 104 and 164. In an example, the D2D P2P link 192 may be supported with any well-known D2D RAT, such as LTE Direct (LTE-D), WiFi Direct (WiFi-D), Bluetooth®, and so on.

The wireless communications system 100 may include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

As illustrated in FIG. 1, the UE 104′ may sense and an object 150 in the environment based on one or more RF sensing. The RF sensing, for example, may include mono-static sensing and multi-static sensing, such as bi-static sensing. In a mono-static sensing system, the UE 104′ both transmits the RF signal and receives the RF signal that is reflected from the object 150. In a multi-static sensing system, the UE 104′ may receive an RF signals reflected from the object 150 that is transmitted from another device, such as base station 102 or UE 164. An example of multi-static sensing is a bi-static system in which one transmitting device transmits and one receiving device receives, but any number of transmitting devices or receiving devices may exist. While UE 104′ is illustrated in FIG. 1 as the receiving device, if desired a base station 102 may be the receiving device, in a mono-static sensing system or a multi-static sensing system, e.g., with a UE 104 (or UE 164) or another base station 102 transmitting the RF signals that are reflected from the object.

The wireless communications system 100 may include a sensing server 172, which may be external to the core network 170 or internal to the core network 170. The sensing server 172 may be used to configure the wireless network to support RF sensing. For example, in some implementations, the sensing server 172 may be configure a sensing resource set for a sensing node, such as UE 104′, and to send the preconfigured resource set to the sensing node for sensing. The sensing server 172 may provide assistance to the sensing node for measuring interference on the resources in the preconfigured resource set to select one or more resources for sensing. For example, the sensing server 172 may provide one or more interference thresholds and timing parameters for measurement of interference. The sensing server 172 may further be configured receive reports from sensing nodes, which may be used to configure sensing resource sets for other sensing nodes or to configure another sensing resource set, e.g. if a previously sent preconfigured resource set has no available resources.

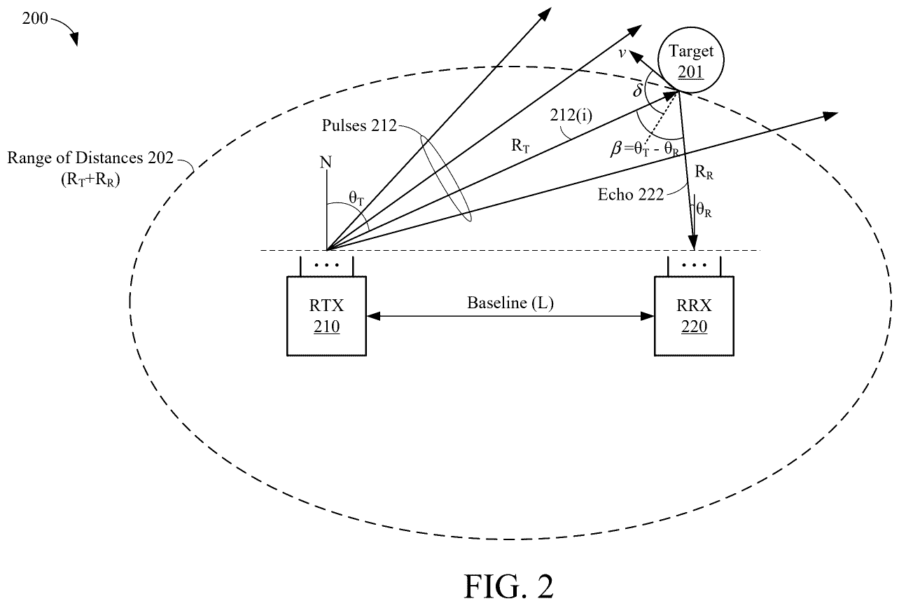

FIG. 2 shows an example bi-static sensing system 200. The bi-static sensing system 200 includes an RF transmitter (RTX) 210 and an RF receiver (RRX) 220. The RF transmitter 210 and the RF receiver 220 are spatially separated by a baseline (L). In some implementations, the RF transmitter 210 may be one example of a base station 102 (or UE 104) and the RF receiver 220 may be an example of one of a different base station 102 (or UE 104) of FIG. 1.

The RF transmitter 210 is configured to transmit RF pulses 212 in a number of directions. Each of the pulses 212 may be a beamformed RF signal having a particular width and directionality. Objects or surfaces along the trajectory of any of the pulses 212 may cause the pulses 212 to reflect or scatter. Reflected pulses may be referred to as “echoes” of the pulses from which they originate. In the example of FIG. 2, a target object 201 is located along the path of one of the RF pulses 212. The RF pulse 212 (i) incident on the target object 201 is reflected as an echo 222. As shown in FIG. 2, the echo 222 is reflected in the direction of the RF receiver 220. The RF receiver 220 may determine ranging, Doppler, or angle information about the target object 201 based on the reception of the echo 222. For example, ranging information with respect to the target object 201 may be determined, including, but not limited to, a distance, direction, or velocity of the target object 201.

In some implementations, the RF receiver 220 may determine a distance (RR) of the target object 201 relative to the RF receiver 220 based, at least in part, on the baseline distance L (between the RF transmitter 210 and the RF receiver 220), an angle of arrival (θ_{R}) of the echo 222, and a time of flight (τ) from the transmission of the incident pulse 212(i) by the RF transmitter 210 to the reception of the resulting echo 222 by the RF receiver 220. More specifically, the distance R_{R} can be calculated according to Equation 1.

$${R}_{R} = \frac{{( {R}_{T} + {R}_{R} )}^{2} - {L}^{2}}{2 ( {R}_{T} + {R}_{R} - L cos {θ}_{R} )} \qquad ( 1 )$$

where R_{T}+R_{R} represents the combined distances from the target object 201 to each of the RF transmitter 210 and the RF receiver 220. As shown in FIG. 2, R_{T}+R_{R} defines a range of distances 202 around the RF transmitter 210 and the RF receiver 220 (in the shape of an ellipse) in which the target object 201 may be located. More specifically, R_{T}+R_{R} can be calculated, according to Equation 2, as a function of the baseline (L), the time of flight of the reflected pulse (τ), and the propagation speed of the RF pulses (cₚ).

$${R}_{T} + {R}_{R} = {c}_{p} τ + L \qquad ( 2 )$$

With reference to Equations 1 and 2, the baseline L and propagation speed cₚ represent fixed or preconfigured values inherent to the sensing system 200. The angle of arrival θ_{R} may be determined based on a time difference of arrival (TDOA) of the echo 222 between different receive antennas of the RF receiver 220 in an antenna array or based on the antenna sector (corresponding to a preset beam of a phased array antenna) used by the RF receiver 220 to receive the echo 222. However, to calculate the time of flight τ, the RF receiver 220 must have knowledge of the time at which the incident pulse 212(i) was transmitted at the position of the receiver. More specifically, the time of flight τ can be calculated, according to Equation 3, as a function of the time of transmission of the incident pulse (Tₚᵤₗₛₑ) and the time of reception of the echo (T_{echo}).

$$τ = {T}_{e c h o} - {T}_{pulse} \qquad ( 3 )$$

For a stationary RF transmitter 210 and stationary RF receiver 220, the target bi-static Doppler frequency is given by:

$${f}_{D} = \frac{2 v}{{c}_{p}} * cos δ * cos ( \frac{β}{2} ) \qquad ( 4 )$$

where ν is the velocity of the target object 201, β is the difference between the angle of departure θ_{T} and the angle of arrival θ_{R}, and δ is the angle between the velocity vector ν and the angle β.

Because the RF transmitter 210 and the RF receiver 220 are implemented in (or correspond to) separate wireless communication devices, the RF transmitter 210 may need to communicate the timing of the transmission of the incident pulse Tₚᵤₗₛₑ to the RF receiver 220. However, because the RF transmitter 210 transmits pulses 212 in a number of directions, the RF transmitter 210 may be unaware as to which of the pulses 212 is incident on the target object 201. Accordingly, the RF transmitter 210 may need to communicate the timing of each of the pulses 212 to the RF receiver 220, and the RF receiver 220 may need to determine which of the pulses 212 resulted in the echo 222. In some implementations, the timing information (Tₚᵤₗₛₑ) of the pulses 212 may be communicated to the RF receiver 220, e.g., as a resource configuration in assistance data.

In some implementations, the RF transmitter 210 also may determine ranging information regarding the target object 201. For example, the RF transmitter 210 may determine its relative distance R_{T} to the target object 201. For example, in some aspects, the RF receiver 220 may provide feedback regarding the echo 222 to the RF transmitter 210. The feedback may include the timing of the echo T_{echo}, the timing of the transmitted pulse Tₚᵤₗₛₑ, the time of flight τ, the angle of arrival θ_{R}, the calculated distance R_{R}, or any combination thereof. The RF transmitter 210 may then calculate the distance R_{T} of the target object 201 based, at least in part, on the angle of departure θ_{T} of the incident pulse 212(i). For example, the RF transmitter 210 may calculate the distance R_{T} by substituting the angle of departure θ_{T} for the angle of arrival θ_{R} in Equation 1. The RF transmitter 210 may determine the angle of departure θ_{T} based on the antenna sector (corresponding to a particular beam of a phased array antenna) used by the RF transmitter 210 to transmit the incident pulse 212(i).

In an RF sensing system, the sensing configuration may be embedded in data transmissions. For example, the network may schedule the sensing resource within the licensed band, e.g., in the same resource with separate waveforms or the same waveform, or using dedicated sensing resource that may be shared by multiple sensing UEs.

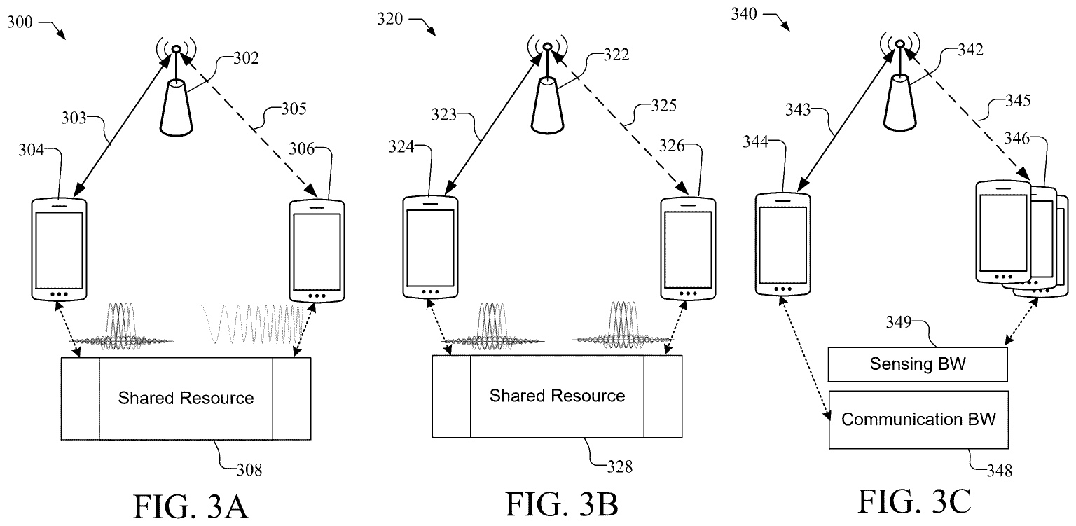

FIG. 3A, by way of example, illustrates a sensing system 300, in in which the same resource is used for communication and sensing with separate waveforms. As illustrated, an AP 302 transmits communication signals 303 to a UE 304 and transmits sensing signals 305 that are used by a sensing UE 306 (a reflecting object is not illustrated in FIG. 3A). The communication signals 303 and sensing signals 305 have a shared resource 308, but as illustrated, the communication signals 303 have an Orthogonal Frequency Division Multiplex (OFDM) waveform, and the sensing signals 305 have a Chirp waveform.

FIG. 3B illustrates a sensing system 320, in in which the same resource 328 is used for communication and sensing based on the same waveform. As illustrated, an AP 322 transmits communication signals 323 to a UE 324 and transmits sensing signals 325 that are used by a sensing UE 326 (a reflecting object is not illustrated in FIG. 3B). The network configures only one waveform, e.g., Orthogonal Time Frequency Space (OTFS) or OFDM, which is used for the communication signals 323 and sensing signals 325 simultaneously.

FIG. 3C illustrates a sensing system 340, in which there is dedicated resource for communication and sensing. As illustrated, an AP 342 transmits communication signals 343 to a UE 344 and transmits sensing signals 345 that are used by multiple sensing UEs 346 (a reflecting object is not illustrated in FIG. 3B). The communication signals 343 have dedicated communication resources 348 and the sensing signals 345 have dedicated sensing resources 349 that are shared by multiple sensing UEs 346.

In the sensing systems shown in FIGS. 3A-3C, interference in the sensing may occur. For example, in sensing systems 300 and 320 that use shared resource, the transmission links (sensing or communication) may involve the interference for the sensing reception. Moreover, interference may occur in sensing system 340, which uses a dedicated sensing resource, as the sensing resource for one sensing UE 346 may collide with scheduled sensing resources of other sensing UEs.

The current 3GPP standards (Release 16) includes an agreement on interference management among the adjacent UEs, referred to as cross link interference (CLI). With CLI, a victim UE performs a CLI measurement at a configured CLI resource, which is transmitted from an aggressor UE.

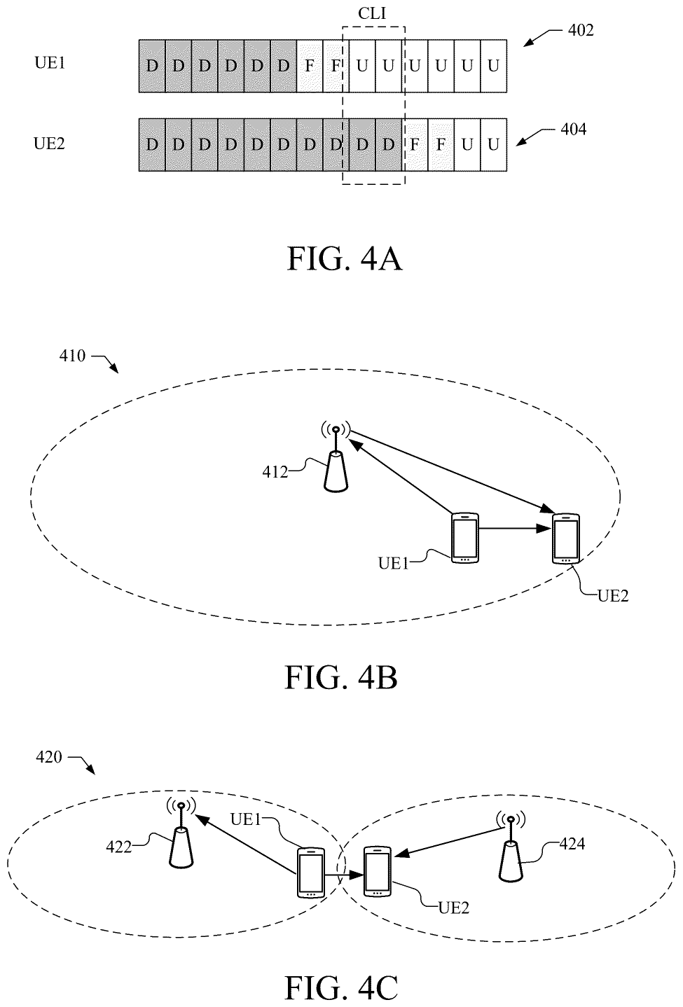

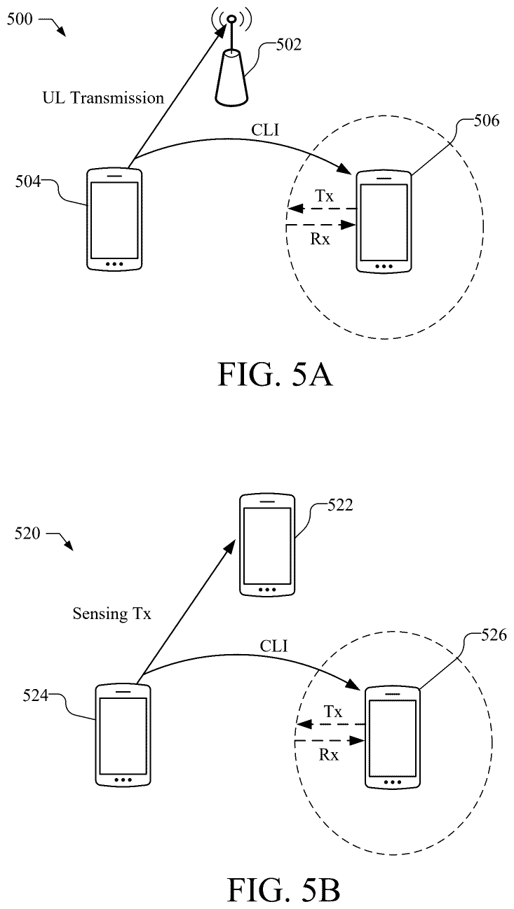

FIG. 4A, by way of example, shows an illustration of cross link interference (CLI) in communication signals 402 from a first UE1, which is the aggressor UE, and communication signals 404 from a second UE2, which is the victim UE. The communication signals 402 and 404 illustrate downlink (D) and uplink (U) resources, and flexible symbols (F), which may be enabled as downlink or uplink resources based on request. As can be seen, the first UE1 transmits uplink resources that overlap with downlink resources received by the second UE2, causing cross link interference.

FIGS. 4B and 4C illustrate CLI in wireless environments 410 and 420, respectively, in which the first UE1 (aggressor UE) transmits uplink signals to APs 412 and 422, respectively, that interfere with the second UE2 ability to receive downlink signals from APs 412 and 424, respectively. As can be seen, CLI may occur between UEs within the same cell (illustrated in FIG. 4B) and in different cells (illustrated in FIG. 4C).

For CLI measurement for communication signals the victim UE reports the interference to a network entity. The network configures the CLI measurement resource, and the victim UE measures and provides the measurement report. Various actions may be taken to eliminate the interference, such as power control or resource scheduling. For example, referring to FIGS. 4A-4C, the first UE1 may transmit uplink signals that generate, the interference for second UE2 for reception of downlink signals at the same time domain portion. Based on the UE1's scheduled UL transmission, the network configures the CLI resource to the victim UE2. The victim UE2 measures the corresponding inference (e.g., signal strength of the uplink signal transmitted by the UE1, and reports the measurement.

During RF sensing, the reception of an interfering signal, e.g., an interfering communication signal or interfering sensing signal, may significantly degrade the sensing performance. For example, interference would impact the accuracy of the Doppler estimation in the sensing, especially for adjacent UEs, e.g., an adjacent sensing UE and communication UE.

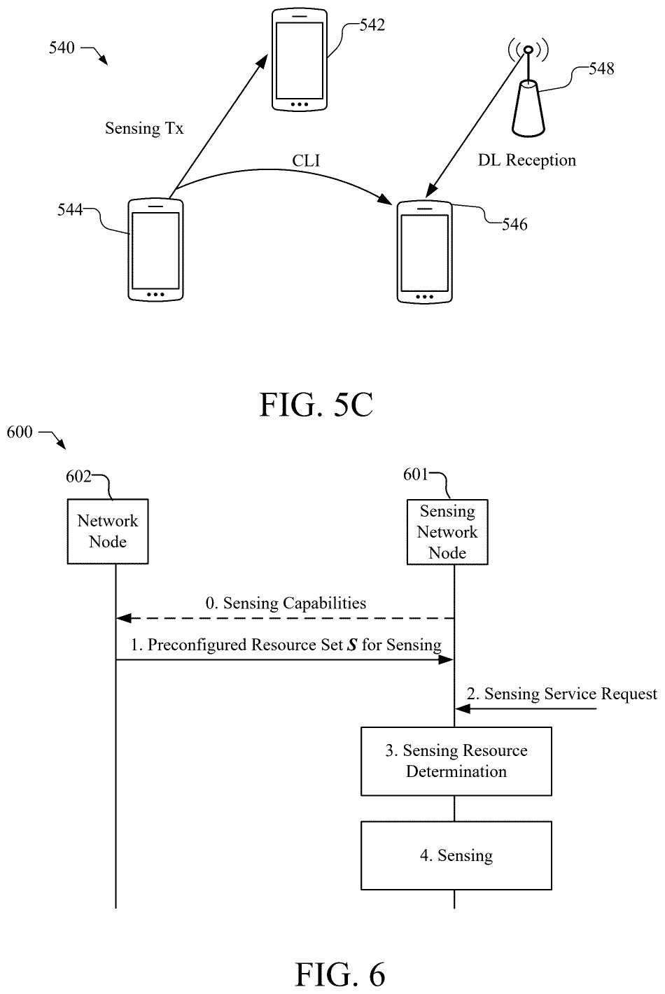

FIGS. 5A, 5B, and 5C, for example, illustrate sensing systems 500, 520 and 540, respectively, in which CLI occurs due to adjacent UEs. For example, sensing system 500 shown in FIG. 5A, includes an aggressor UE 504 transmitting an uplink signal to an AP 502, which may interfere with sensing performed by sensing UE 506 (illustrated as mono-static sensing, but may be bi-static sensing). In sensing system 520, shown in FIG. 5B, the aggressor UE 524 transmits a sensing signal (for use by UE 522), and the sensor signal may interfere with sensing performed by sensing UE 526 (illustrated as mono-static sensing, but may be bi-static sensing). In sensing system 540, shown in FIG. 5C, the aggressor UE 544 transmits a sensing signal (for use by UE 542), and the sensor signal may interfere with reception by UE 546 of a downlink signal from the AP 548.

In ISAC, it is a challenge to control such interference. For example, as illustrated in FIG. 5A, with a shared resource (e.g., discussed in reference to FIGS. 3A and 3B), the communication transmit (Tx) link by UE 504 would interfere with the sensing reception by UE 506. As illustrated in FIG. 5B, with use of a dedicated sensing resource (e.g., discussed in reference to FIG. 3C), the sensing transmission by UE 524 would impact the sensing reception by UE 526. Additionally, with use of a shared resource (e.g., discussed in reference to FIGS. 3A and 3B), the transmission of the sensing signals by UE 544 would also impact the reception of downlink communication signals by UE 546 from AP 548. Interference between communication and sensing signals among adjacent UEs may be considered similar to for interference between communication signals. Accordingly, it may be advantageous to extend the CLI procedure for communication signals to sensing resource detection.

Sensing is typically considered a UE-centric service, and diverse sensing scenarios require frequent sensing resource configuration. Frequent sensing resource configuration, however, would lead to large signaling cost and latency. For the measurement and management of the CLI interference during sensing, one option may be to utilize the current CLI mechanism for communication signals as discussed in reference to FIGS. 4A-4C. The use of such a procedure for sensing, however, would require an excessive amount of resource overhead cost. The resource overhead cost may be considered excessive particularly because, in most scenarios, the sensing function may be considered a secondary priority service compared to the communication traffic in the licensed band. For example, frequent CLI measurement and resource scheduling for gesture sensing control that randomly triggers the sensing service, would be inefficient.

Accordingly, as discussed herein, interference in sensing may be controlled using a pre-configured sensing resource set, from which a sensing node may determine the resource to be used for sensing in response to a sensing request. The sensing node may be configured to detect interference in the resources from the preconfigured resource set and to use resources with little or no interference for sensing to avoid the CLI among devices. Moreover, the sensing node may generate and provide interference measurement reports for the sensing resource management in the network.

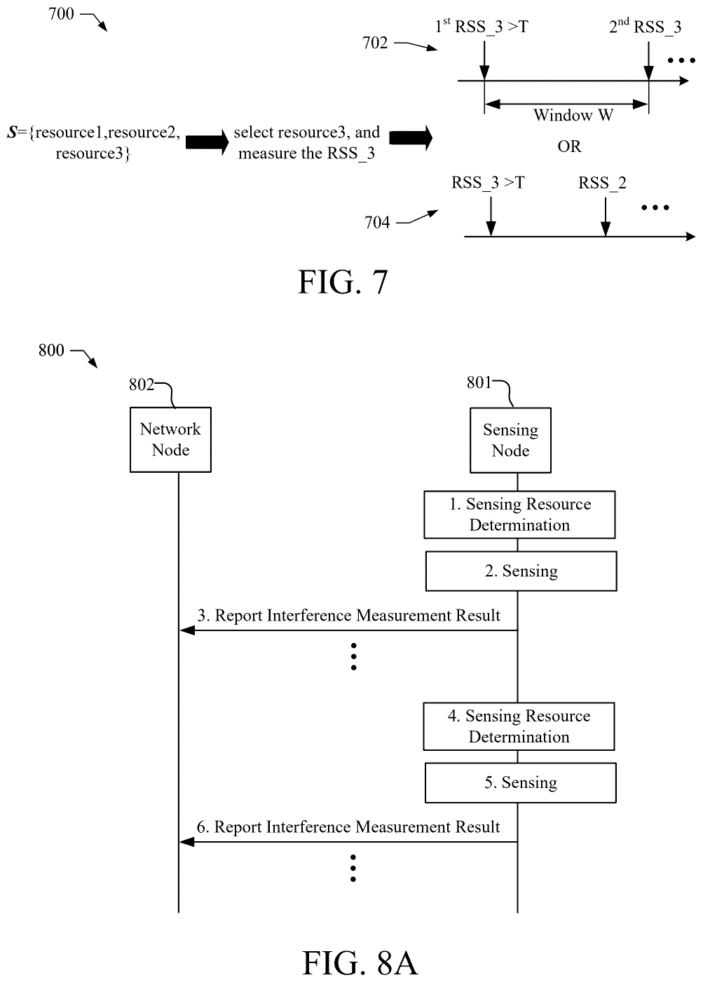

FIG. 6 is a message flow 600 between a sensing node 601 and another network node 602 for RF sensing with reduced interference. The sensing node 601 may be any of the access points or sensing UEs discussed herein, e.g., a base station 102 or UE 104. The sensing node 601 may be the transmitting and receiving entity in a mono-static sensing system or may be the transmitting entity in a multi-static sensing system. The network node 602 may be a sensing server 172 shown in FIG. 1, or may be another entity in the sensing system, such as a receiving entity in a multi-static sensing system.

At stage 1, the network node 602 configures a sensing resource set S for sensing and sends the preconfigured resource set S to the sensing node 601. Thus, when the sensing node 601 accesses the network, or requires the resource configuration for sensing, the network node 602 does not explicitly indicate the sensing resource to be used by the sensing node 601, but instead configures a sensing resource set S, which includes a number of resources that may be used for sensing. For example, the sensing resource set S may include a number of positioning reference signal (PRS) or other reference signal resources, and may be defined as, e.g., Sensing-resource-set={resource1, resource2, resource3, . . . }. In some implementations, he preconfigured resource set S configuration may be based on capabilities of the sensing node 601. For example, the sensing node 601 may provide its sensing capabilities to the network node 602, e.g., in a capabilities message illustrated in optional stage 0 in FIG. 6, and the network node 602 may generate the preconfigured resource set S based on the capabilities of the sensing node 601. For example, the sensing node 601 may have the capability to perform high-granularity sensing within a defined range, and in response the preconfigured resource set S may be produced with resources having a large bandwidth, which is sufficient to enable the high-granularity sensing. The preconfigured resource set S may be additionally or alternatively based on the RRC signaling from the network (e.g., base stations) to the sensing node 601 (e.g., a UE). Different use cases or sensing scenarios may have different requirements on sensing resources, and accordingly, the network node 602 may generate and send the sensing node 601 multiple preconfigured resource sets for sensing.

At stage 2, the sensing node 601 receives a sensing service request. The sensing service request may be received from the network node 602 or from another entity. It should be understood that the sensing service request may be received prior to receiving the preconfigured resource set S from the network node 602. For example, the sensing node 601 may receive the sensing service request, and then may request sensing resources from the network node 602 and the network node 602 may provide the preconfigured resource set S in response.

At block 3, the sensing node 601 may determine one or more resources to be used as sensing resources from the preconfigured resource set S, e.g., in response to receiving the sensing service request in stage 2. For example, the sensing node 601 may measure each separate resource from the preconfigured resource set S and then select one or more of the resources as the sensing resource(s) based on the measurements. The one or more resources selected as sensing resources, for example, may be the resources that are determined to have the best sensing performance. For example, the sensing node 601 may measure the interference of each resource in the preconfigured resource set S and may select one or more resources with the least interference or without interference as the sensing resources. The interference on a resource, for example, may be measured based on a signal strength (e.g., received signal strength (RSS)) measurement of the resource. The one or more resources may be selected based on other parameters that may be beneficial to sensing, such as the largest available bandwidth. The sensing node 601 may select the resources for measurement sequentially or simultaneously. For example, the resources may be selected and measured one by one or simultaneously. For example, a single resource may be selected and measured, and if the resource is determined to be occupied, a different resource may be selected and measured until an unoccupied resource is found. In another example, many resources may be selected and all of the selected resources measured simultaneously to detect one or more un-occupied resources that may be used for sensing.

At block 4, the sensing node 601 occupies the selected one or more sensing resources and performs sensing. For example, the sensing node 601 may transmit reference signals (e.g., PRS or other reference signals) with the one or more sensing resources. In a mono-static sensing configuration, the sensing node 601 may receive the reflected signals (echo) from an object in the environment, while in a multi-static sensing configuration, a separate sensing node will receive the reflected signals (echo) from an object in the environment.

With the use of a pre-configuration resource set S with which the sensing node 601 may determine of one or more sensing resources to use for sensing, benefits, such as low overhead, power saving, and lower latency may be achieved. Sensing, for example, may be considered as a sensing node-centric service, in which except the resource configuration, most of the actions can be done by the sensing node self. With the use of the pre-configuration resource set S, frequent sensing resource configuration by the network can be avoided, thereby limiting overhead. Moreover, the sensing node may easily adjust the sensing actions and sensing resources in quick response to events, producing low latency.

Without the network to coordinate sensing resources, the self determination of sensing resources by a sensing node may lead to interference in these resources, as discussed in reference to FIGS. 5A-5C. To manage the interference that may be caused by sensing resources among sensing nodes, the sensing nodes may be configured to detect interference in resources in the preconfigured resource set S, e.g., for the sensing resource determination (illustrated in block 3 of message flow 600).

By way of example, in stage 1 of message flow 600, along with the sensing resource set S configuration, the network node 602 may also configure and provide to the sensing node 601 one or more parameters to be used by the sensing node 601 for selecting one or more resources in block 3 of message flow 600. By way of example, parameters that may be used to selecting one or more resources may be an interference threshold T and, optionally, a time window W. The interference threshold T may be defined based on the measured signal strength, e.g., RSS. In some implementations, the entire preconfigured resource set S may be configured with a single threshold T, or different resources may be configured with different thresholds T, e.g., each resource may be associated with a specific threshold T. Moreover, different interference thresholds T may be used for different use cases or sensing scenarios. The time window W may be used to indicate when interference measurements should be made or should not be made.

The sensing node 601 may measure the signal strength, e.g., RSS, of the selected sensing resources in the given resource set. Only the one or more resources with a signal strength less than the interference threshold T may be selected for the sensing service. If all the selected resources have a signal strength that is greater the interference threshold T, the sensing node 601 may wait until the time window W expires before measuring the interference on the resources again. A signal strength of a resource that is larger than the interference threshold T indicates that the resource is occupied by another device, and the sensing node 601 should not enable sensing using that resource, as this will lead to interference with the other device. If all resources have a signal strength greater than the interference threshold T, then the sensing operation may not be performed without causing interference, and thus, should be delayed for a period of time, e.g., the time window W, before rechecking the interference on the resources.

In some implementations, the sensing node 601 may be preconfigured with one or more parameters to be used for selecting one or more resources. Note: For example, instead of obtaining the parameters from the network node 602 through signaling at stage 1, the parameters may be predefined in the standard and the sensing node 601 may be configured pursuant to the standard. For example, different interference thresholds T may be associated with different sensing use-cases, which may be stored in a sensing node 601, e.g., in a look-up table. Based on the current sensing use-case, the sensing node 601 may determine the corresponding interference threshold T to use. For example, there may be two sensing use cases: room scale sensing with the mapped threshold −10 dBm, and short-range gesture sensing with the mapped threshold 0 dBm. If the measured interference level is −5dBm in pattern 1, this pattern is only available for the short-range sensing, and not used for the room-scale sensing.

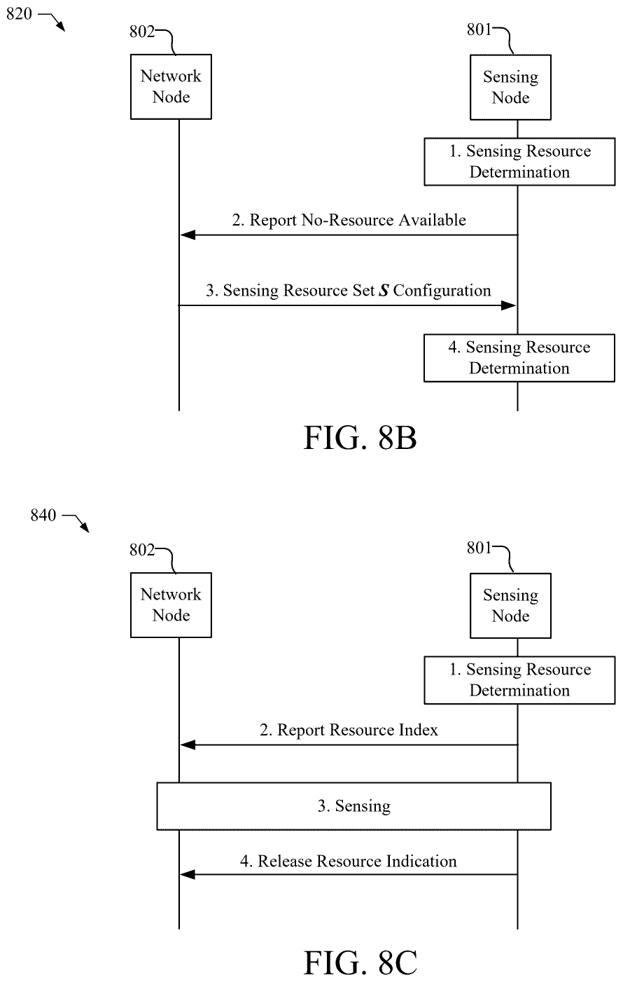

FIG. 7, by way of example, illustrates a process 700 of sensing resource determination using interference detection, e.g., by a sensing node 601 in block 3 shown in FIG. 6. As illustrated, a preconfigured resource set S={resource1, resource2, resource3} is provided. In the example process 700, a resource3 is selected from the preconfigured resource set S and the sensing node 601 measures the signal strength (RSS_3) of the resource3. If the signal strength (RSS_3) of the selected resource (resource3), is larger than the interference threshold T, then resource3 is occupied by another device, and resource3 should not be enabled for sensing. As illustrated by option 702, the sensing node 601 may wait for the expiration of time window W before measuring the signal strength (RSS_3) of the selected resource (resource3) again. As illustrated by option 704, on the other hand, the sensing node 601, without waiting, may directly select another resource, e.g., resource2, to measure the signal strength (RSS_2), and the measured signal strength RSS_2 would then be compared to the same interference threshold T or to another interference threshold T associated with resource 2. In option 704, the sensing node 601 may measure the signal strength of each selected resource, and if all resources in the preconfigured resource set S have been determined to have interference, the sensing node 601 may wait for the expiration of the time window W before remeasuring the interference on selected resources. With either option 702 or 704, the process 700 may continue, e.g., until a selected resource is found to have interference below the threshold level, before occupying the selected resource and performing the sensing operation (block 4 of message flow 600).

The sensing node 601 may generate and provide an interference measurement reports for sensing resource management in the network. For example, after the interference measurement, the sensing node 601 may report the measurement to the network, e.g., the network node 602 or another network entity such as a sensing server 172.

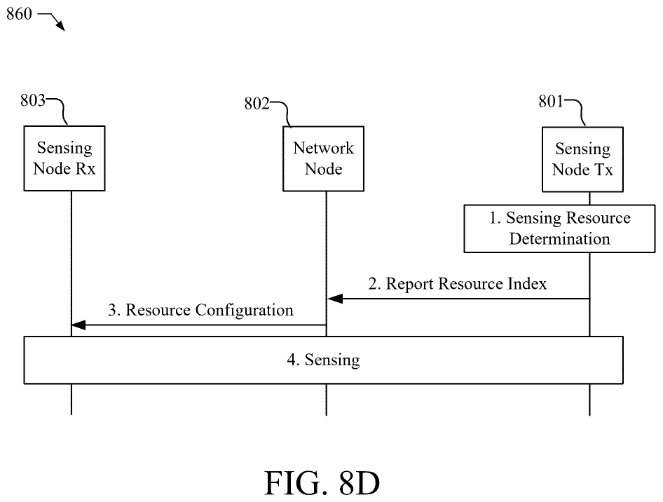

FIGS. 8A-8D show message flows between a sensing node 801 and network node 802 illustrating various options for providing interference reports. The sensing node 801 may be similar to sensing node 601 shown in FIG. 6, which may be any of the access points or sensing UEs discussed herein. The sensing node 801 may be the transmitting and receiving entity in a mono-static sensing system or may be the transmitting (Tx) entity in a multi-static sensing system, and a separate receiving Rx sensing node 803 (shown in FIG. 8D) may receive the reflected sensing signals. The network node 802 may be similar to network node 602 shown in FIG. 6, which may be a sensing server 172 shown in FIG. 1. The message flows in each of FIGS. 8A-8D may be an extension of the message flow 600 shown in FIG. 6, e.g., with block 1 illustrated in each of FIGS. 8A-8D corresponding to block 3 of message flow 600 shown in FIG. 6.

FIG. 8A shows a message flow 800 in which the reporting pattern for the interference reports may be defined and the sensing node 801 periodically reports the interference measurements. The network, e.g., network node 802, may track the resource status of the preconfigured resource set S.

At block 1 of message flow 800, the sensing node 801 determine one or more resources to be used as sensing resources from the preconfigured resource set S, including measuring the interference on the resources as discussed above in reference to block 3 of message flow 600.

At block 2, the sensing node 801 occupies the selected one or more sensing resources and performs sensing, e.g., as discussed above in reference to block 4 of message flow 600.

At stage 3, the sensing node 801 sends a report with interference measurements from block 1 to the network node 802. The network node 802, for example, may be the same network node 802 that provides the preconfigured resource set S to the sensing node 801 or may be a separate network node 802. In one implementation, the report may include the interference measurement made for all of the resources in the preconfigured resource set S. In one implementation, only the resources with interference measurement that exceed the interference threshold T, i.e., the occupied resources, may be reported. The report metric, for example, may be the received signal strength indicator (RSSI), and the sensing node 801 may use one layer-3 filter to track the interference level of the resources in long term. With such measurement reports, the network node 802 would know which resources are not available for the sensing. In subsequent resource set S configurations (for the sensing node 801 or for other nearby sensing nodes), the unavailable resources may be excluded. The layer-3 filter in the sensing node 801 may be used to calculate the interference status of the resources in long-term, so that a single measurement instance with high interference would not represent that the resource is not available. In some implementations, the report may further include the sensing results from block 2. Moreover, in some implementations, the report in stage 3 may be sent before performing the sensing in block 2.

As illustrated, the process may report. For example, at stage 4, the sensing node 801 may again determine one or more resources to be used as sensing resources from the preconfigured resource set S.

At stage 5, the sensing node 801 occupies the selected one or more sensing resources and performs sensing.

At stage 6, the sensing node 801 sends a report with interference measurements from stage 4 to the network node 802.

FIG. 8B shows a message flow 820 in which the sensing node 801 actively reports the interference status when there are no available resources for sensing.

At block 1 of message flow 820, the sensing node 801 determine one or more resources to be used as sensing resources from the preconfigured resource set S₁, including measuring the interference on the resources as discussed above in reference to block 3 of message flow 600. In the present example, after the interference measurement, the sensing node 801 determines that there are no resources available for sensing.

At stage 2, the sensing node 801 sends a report based on the interference measurements from block 1 to the network node 802. The sensing node 801, for example, may provide an indication when no resources from the preconfigured resource set S₁ are available for sensing. In one implementation, the report may include a flag, e.g., a single bit, to indicate that the resources are not available for sensing. In one implementation, the report may include the interference measurements, e.g., the RSSI, of the measured resources.

At stage 3, the network node 802 may generate a re-configured resource set S₂ based on the report received at stage 2, and provide the re-configured resource set S₂ to the sensing node 801.

At stage 4, the sensing node 801 begins the process over by determining one or more resources to be used as sensing resources from the new re-configured resource set S₂, including measuring the interference on the resources as discussed above in reference to block 3 of message flow 600.

FIG. 8C shows a message flow 840 in which once a resource is selected for sensing, the sensing node 801 reports the resource back to the network node 802.

At block 1 of message flow 840, the sensing node 801 determine one or more resources to be used as sensing resources from the preconfigured resource set S, including measuring the interference on the resources as discussed above in reference to block 3 of message flow 600. The sensing node 801 may select one or more of the resources for sensing based on the interference measurement.

At stage 2, the sensing node 801 sends a report based on the interference measurements from block 1 to the network node 802. The report, for example, includes an indication of the one or more resources selected to be used for sensing. The indication, for example, may be a resource index, or a single bit indication that the resource has been selected.

At block 3, the sensing node 801 occupies the selected one or more sensing resources and performs sensing, e.g., as discussed above in reference to block 4 of message flow 600. The process of message flow 840 is advantageous as it enables the network node 802 to be aware of the status of resources and whether they are being used for sensing. For example, once the network node 802 is aware that the sensing node 801 is using the selected resources for sensing, the network node 802 may exclude the selected resources during the configuration of a sensing resource set S for other nearby sensing nodes.

At block 4, the sensing node 801 may send a message to the network node 802 indicating that the sensor resources have been released after sensing from block 3 is completed. Similar to the report in stage 2, the release may use a resource index, or a single bit indication that the resource has been released.

FIG. 8D shows a message flow 860 that illustrates a bi-static sensing setting, in which the transmitting (Tx) sensing node 801 reports the resource selected for sensing to the network node 802, which then provide an indication of the selected resource to the receiving (Rx) sensing node 803 for sensing reception.

At block 1 of message flow 860, the sensing node 801 determine one or more resources to be used as sensing resources from the preconfigured resource set S, including measuring the interference on the resources as discussed above in reference to block 3 of message flow 600. The sensing node 801 may select one or more of the resources for sensing based on the interference measurement.

At stage 2, the sensing node 801 sends a report based on the interference measurements from block 1 to the network node 802. The report, for example, includes an indication of the one or more resources selected to be used for sensing. The indication, for example, may be a resource index, as the network node 802 knows the preconfigured resource set S.

At stage 3, the network node 802 configures the selected resource and sends the resource configuration to the receiving (Rx) sensing node 803. The network node 802 may send the resource configuration to the receiving (Rx) sensing node 803 because the receiving (Rx) sensing node 803 is not be aware of the preconfigured resource set S, and accordingly, may not know the resource index.

At block 4, the transmitting (Tx) sensing node 801 occupies the selected one or more sensing resources and performs sensing, e.g., as discussed above in reference to block 4 of message flow 600, e.g., by transmitting the sensing signals on the one or more occupied resources, and the receiving (Rx) receives any reflected sensing signals (echoes) on the one or more sensing resources. Additionally, as discussed in message flow 840, because the network node 802 is aware that the sensing node 801 is using the selected resources for sensing, the network node 802 may exclude the selected resources during the configuration of a sensing resource set S for other nearby sensing nodes.

After interference measurement of the resources in the preconfigured resource set S, if there is not a resource available for sensing, the sensing procedure fails this iteration. The sensing node may measure the resources again after one time duration, e.g., after a time window W. In the next iteration, if the sensing node again fails to find an available resource for sensing, the procedure may be repeated. In some implementations, the waiting time window W after each repetition may increase. The waiting time window W for example, may be related to a repetition index (n), e.g., the waiting time window may be nW. For example, the waiting time widow for a first repetition (n=1) may be W, and the waiting time for a second repetition (n=2) may be 2W. The network, e.g., the network node 602 in stage 1 of message flow 600 of FIG. 6, may configure and send the sensing node 601 the maximum measurement waiting time. For example, in one implementation, the maximum measurement waiting time may be configured by an upper limit to the waiting time, and in another implementation, the maximum measurement waiting time may be configured by an upper limit on the number of repetitions. By increasing the waiting time window between failed sensing procedures, and configuring maximum measurement waiting time, power consumption is reduced by avoiding performing failed sensing procedures at a regular interval.

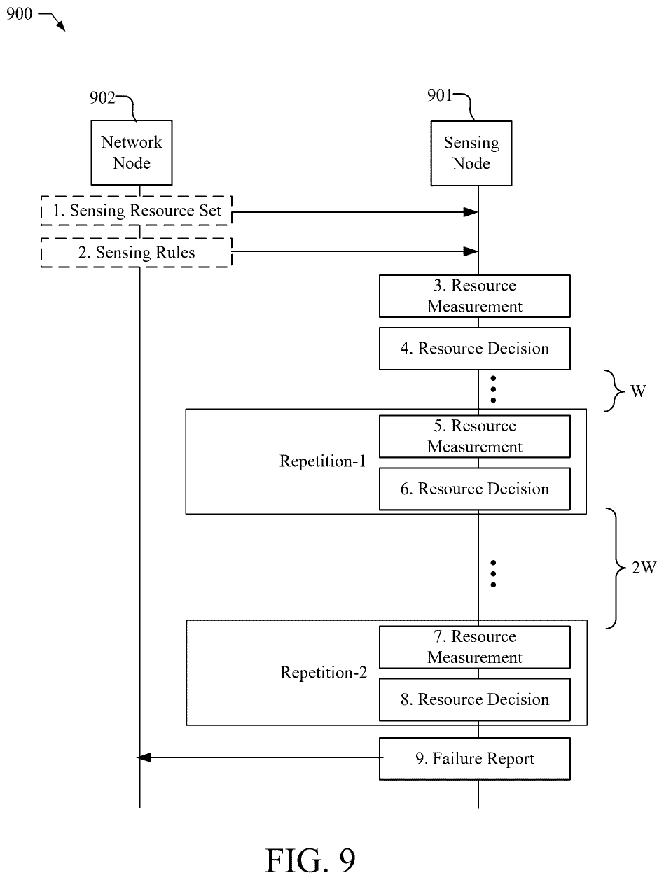

FIG. 9 show a message flow 900 between a sensing node 901 and network node 902 illustrating the use of the re-measurement time window W. The sensing node 901 may be similar to sensing node 601 shown in FIG. 6, which may be any of the access points or sensing UEs discussed herein. The network node 902 may be similar to network node 602 shown in FIG. 6, which may be a sensing server 172 shown in FIG. 1. The message flow 900 in FIG. 9 may be similar to, or an extension of the message flow 600 shown in FIG. 6.

At stage 1, which may be optional, the network node 902 may configure a sensing resource set S for sensing and send the preconfigured resource set S to the sensing node 901. Stage 1 of message flow 900 may be similar to stage 1 of message flow 600, as discussed above. In some implementations, the sensing node 901 may receive the preconfigured resource set S from another source or may be preconfigured with a process to generate the preconfigure d resource set S on its own, thereby obviating stage 1.

At stage 2, which may be optional, the network node 902 may configure sensing rules and send the sensing rules to the sensing node 801. The sensing rules, for example, may be the parameters used for measuring interference in the resources and for determining which resources from the preconfigured resource set S to be used for sensing. For example, the sensing rules may include a waiting time window W for remeasuring interference when no resources are found to be available for sensing. The sensing rules may further an interference threshold T as well. The sensing rules may include an indication of the increase in the waiting time window W between repetitions. The sensing rules may include an indication of the maximum measurement waiting time, e.g., an upper limit to the waiting time or an upper limit of the number of repetitions. In some implementations, the sensing rules may be combined with the message sent in stage 1 to the sensing node 901 with the preconfigured resource set. In some implementations, the sensing node 901 may be pre-configured with the sensing rules, thereby obviating the need for stage 2.

At block 3, the sensing node 901 may perform interference measurements of the resources in the preconfigured resource set S, e.g., as discussed in reference to block 3 of message flow 600.

At block 4, the sensing node 901 determines whether any of the resources may be selected as a sensing resource, e.g., whether the interference on the resources is below the interference threshold T, e.g., as discussed in reference to block 3 of message flow 600 and in reference to FIG. 7. It should be understood that blocks 3 and 4 need not be performed sequentially, but may be combined, e.g., with a determination of whether each resource may be used as a sensing resource (block 4) being made before measuring the interference in the next resource (block 3). The combination of blocks 3 and 4 of message flow 900, for example, may be similar to block 3 of message flow 600.

Assuming no resources are determined to be available for sensing by the sensing node 901 in blocks 3 and 4, the sensing node 901 waits the waiting time window W before performing the first repetition (Repetition-1), including stages 5 and 6, which are repetitions of stages 3 and 4, respectively.

Assuming no resources are determined to be available for sensing by the sensing node 901 in blocks 5 and 6 in the first repetition (Repetition-1), the sensing node 901 waits an increased amount of time, e.g., the waiting time window 2W, before performing a second repetition (Repetition-2), including stages 7 and 8, which are repetitions of stages 3 and 4, respectively. The increase in the waiting time window may be related to the repetition index (n, from Repetition-(n)), or may be otherwise configured.

At stage 9, the sensing node 901 may generate and send a failure report to the network node 902, if the upper limit of maximum measurement waiting time, e.g., the upper limit to the waiting time or the upper limit of the number of repetitions, is reached and sensing node 901 cannot fine an available resource for sensing. The network node 902 may generate and send to the sensing node 901 another sensing resource set S for measurement, and sensing node 901 may repeat the process.

In some implementations, in addition to or instead of sending a failure report in stage 9, the sensing node 901 may turn to inactive idle mode to wait an increased waiting time window. For example, in some implementations, sensing node 901 may enter an inactive idle mode between stages 6 and 7 during the waiting time window 2W. In other implementations, the sensing node 901 may enter an inactive idle mode after reaching the upper limit of the maximum measurement waiting time.

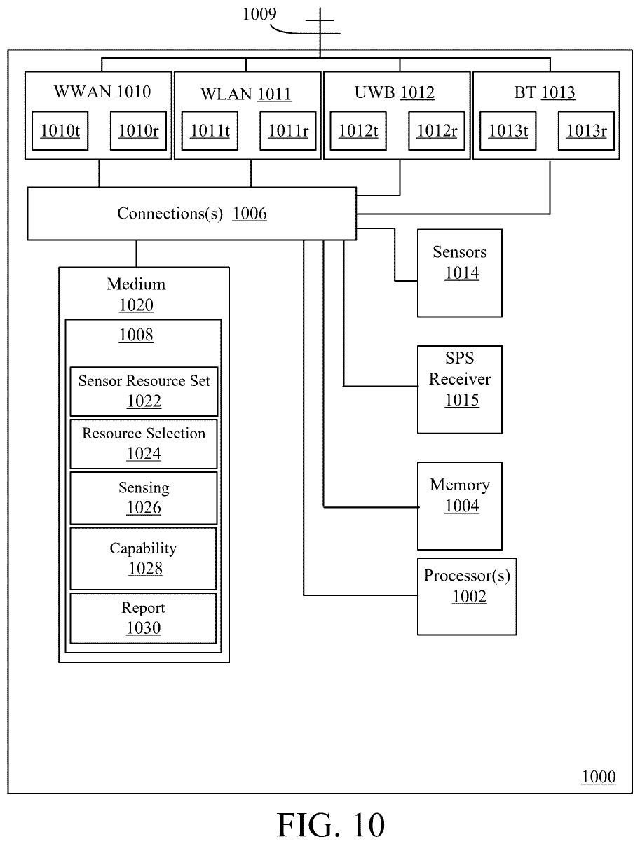

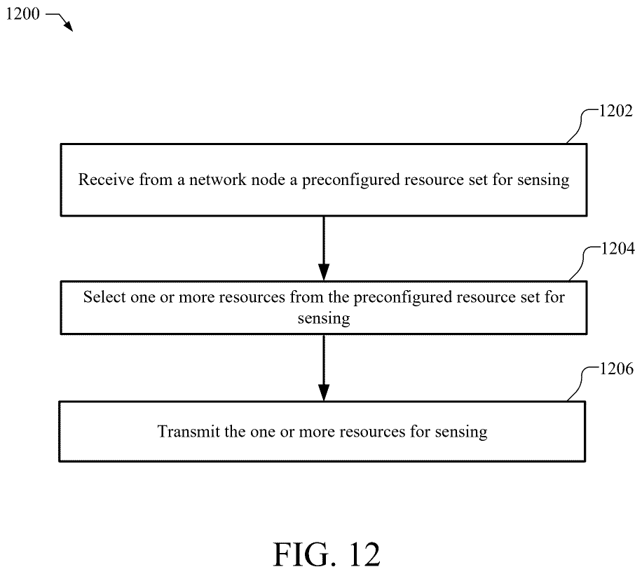

FIG. 10 shows a schematic block diagram illustrating certain exemplary features of a sensing node 1000, e.g., which may be UE 104 or base station 102 shown in FIG. 1, or any of the sensor nodes, 601, 801, or 901, shown in FIGS. 6, 8A-8D, and 9, respectively, and supports sensing using a preconfigured resource set in a wireless network, as described herein. The sensing node 1000, for example, may perform the message flows 600, 800, 820, 840, 860, and 900, shown in FIGS. 6, 8A-8D, and 9, and the process flow 1200 shown in FIG. 12 and accompanying techniques as discussed herein. The sensing node 1000 may include, for example, one or more processors 1002, memory 1004, an external interface such as at least one wireless transceivers (e.g., wireless network interface) illustrated as WWAN transceiver 1010, WLAN transceiver 1011, an Ultra-Wideband (UWB) transceiver 1012 and a Bluetooth (BT) transceiver 1013, SPS receiver 1015, and one or more sensors 1014, which may be operatively coupled with one or more connections 1006 (e.g., buses, lines, fibers, links, etc.) to non-transitory computer readable medium 1020 and memory 1004. The SPS receiver 1015, for example, may receive and process SPS signals from satellite vehicles. The one or more sensors 1014, for example, may be an inertial measurement unit (IMU) that may include one or more accelerometers, one or more gyroscopes, a magnetometer, etc. The sensing node 1000 may further include additional items, which are not shown, such as a user interface that may include e.g., a display, a keypad or other input device, such as virtual keypad on the display, through which a user may interface with the sensing node. In certain example implementations, all or part of sensing node 1000 may take the form of a chipset, and/or the like.

The sensing node 1000 may include at least one wireless transceiver, such as wireless transceiver 1010 for a WWAN communication system and wireless transceiver 1011 for a WLAN communication system, UWB transceiver 1012 for a UWB communication system, BT transceiver 1013 for a Bluetooth communication system, or a combined transceiver for any of WWAN, WLAN, UWB, and BT. The WWAN transceiver 1010 may include a transmitter 1010t and receiver 1010r coupled to one or more antennas 1009 for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The WLAN transceiver 1011 may include a transmitter 1011t and receiver 1011r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The UWB transceiver 1012 may include a transmitter 1012t and receiver 1012r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The BT transceiver 1013 may include a transmitter 1013t and receiver 1013r coupled to one or more antennas 1009 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The transmitters 1010t, 1011t, 1012t, and 1013t may include multiple transmitters that may be discrete components or combined/integrated components, and/or the receivers 1010r, 1011r, 1012r, and 1013r may include multiple receivers that may be discrete components or combined/integrated components. The WWAN transceiver 1010 may be configured to communicate signals (e.g., with base stations and/or one or more other devices) according to a variety of radio access technologies (RATs) such as 10G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio may use mm-wave frequencies and/or sub-6 GHZ frequencies. The WLAN transceiver 1011 may be configured to communicate signals (e.g., with access points and/or one or more other devices) according to a variety of radio access technologies (RATs) such as 3GPP LTE-V2X (PC5), IEEE 1002.11 (including IEEE 1002.11p), WiFi, WiFi Direct (WiFi-D), Zigbee etc. The UWB transceiver 1012 may be configured to communicate signals (e.g., with access points and/or one or more other devices) according to a variety of radio access technologies (RATs) such as personal area network (PAN) including IEEE 802.15.3, IEEE 802.15.4, etc. The BT transceiver 1013 may be configured to communicate signals (e.g., with access points and/or one or more other devices) according to a variety of radio access technologies (RATs) such as a Bluetooth® network. The transceivers 1010 1011, 1012, and 1013 may be communicatively coupled to a transceiver interface, e.g., by optical and/or electrical connection, which may be at least partially integrated with the transceivers 1010, 1011, 1012, 1013.

In some embodiments, sensing node 1000 may include antenna 1009, which may be internal or external. sensing node antenna 1009 may be used to transmit and/or receive signals processed by wireless transceivers 1010, 1011, 1012, 1013. In some embodiments, sensing node antenna 1009 may be coupled to wireless transceivers 1010, 1011, 1012, 1013. In some embodiments, measurements of signals received (transmitted) by sensing node 1000 may be performed at the point of connection of the sensing node antenna 1009 and wireless transceivers 1010, 1011, 1012, 1013. For example, the measurement point of reference for received (transmitted) RF signal measurements may be an input (output) sensing node of the receiver 1010r (transmitter 1010t) and an output (input) sensing node of the sensing node antenna 1009. In a sensing node 1000 with multiple sensing node antennas 1009 or antenna arrays, the antenna connector may be viewed as a virtual point representing the aggregate output (input) of multiple sensing node antennas.

The one or more processors 1002 may be implemented using a combination of hardware, firmware, and software. For example, the one or more processors 1002 may be configured to perform the functions discussed herein by implementing one or more instructions or program code 1008 on a non-transitory computer readable medium, such as medium 1020 and/or memory 1004. In some embodiments, the one or more processors 1002 may represent one or more circuits configurable to perform at least a portion of a data signal computing procedure or process related to the operation of sensing node 1000.

The medium 1020 and/or memory 1004 may store instructions or program code 1008 that contain executable code or software instructions that when executed by the one or more processors 1002 cause the one or more processors 1002 to operate as a special purpose computer programmed to perform the techniques disclosed herein. As illustrated in sensing node 1000, the medium 1020 and/or memory 1004 may include one or more components or modules that may be implemented by the one or more processors 1002 to perform the methodologies described herein. While the components or modules are illustrated as software in medium 1020 that is executable by the one or more processors 1002, it should be understood that the components or modules may be stored in memory 1004 or may be dedicated hardware either in the one or more processors 1002 or off the processors.

A number of software modules and data tables may reside in the medium 1020 and/or memory 1004 and be utilized by the one or more processors 1002 in order to manage both communications and the functionality described herein. It should be appreciated that the organization of the contents of the medium 1020 and/or memory 1004 as shown in sensing node 1000 is merely exemplary, and as such the functionality of the modules and/or data structures may be combined, separated, and/or be structured in different ways depending upon the implementation of the sensing node 1000.

The medium 1020 and/or memory 1004 may include a sensor resource set module 1022 that when implemented by the one or more processors 1002 configures the one or more processors 1002 to receive, via the external interface including one or more of wireless transceivers 1010, 1011, 1012, and 1013, a preconfigured resource set for sensing as discussed herein, including in FIG. 6 and FIG. 9.

The medium 1020 and/or memory 1004 may include a resource selection module 1024 that when implemented by the one or more processors 1002 configures the one or more processors 1002 to select one or more resources from the preconfigured resource set for sensing as discussed herein, including in FIGS. 6, 8A-8D, and 9. The one or more processors 1002 may be configured, for example, to measure interference of resources in the preconfigured resource set to select one or more resources. The one or more processors 1002, for example, may measure interference based on a measured received signal strength of resources received via the external interface including one or more of wireless transceivers 1010, 1011, 1012, and 1013. As discussed herein, interference may be measured based on one or more interference thresholds received via the external interface including one or more of wireless transceivers 1010, 1011, 1012, and 1013. As discussed herein, interference may be further measured based on a time window, received via the external interface including one or more of wireless transceivers 1010, 1011, 1012, and 1013, used for waiting between measurements of interference, and which may be increased after each instance of determining resources have interference.

The medium 1020 and/or memory 1004 may include a sensing module 1026 that when implemented by the one or more processors 1002 configures the one or more processors 1002 to perform sensing, e.g., transmit via the external interface including one or more of wireless transceivers 1010, 1011, 1012, and 1013, one or more resources for sensing, as discussed herein.

The medium 1020 and/or memory 1004 may include a capability module 1028 that when implemented by the one or more processors 1002 configures the one or more processors 1002 to send a capability message, e.g., via the external interface including one or more of wireless transceivers 1010, 1011, 1012, and 1013, to a network node for generating a preconfigured resource set for sensing.

The medium 1020 and/or memory 1004 may include a report module 1030 that when implemented by the one or more processors 1002 configures the one or more processors 1002 to send a report, e.g., via the external interface including one or more of wireless transceivers 1010, 1011, 1012, and 1013, to a network node based on the interference of resources, e.g., as discussed in FIGS. 8A-8D and FIG. 9.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1020 or memory 1004 that is connected to and executed by the one or more processors 1002. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1008 on a non-transitory computer readable medium, such as medium 1020 and/or memory 1004. Examples include computer readable media encoded with a data structure and computer readable media encoded with a computer program code 1008. For example, the non-transitory computer readable medium including program code 1008 stored thereon may include program code 1008 to support sensing using a preconfigured resource set for sensing in a wireless network in a manner consistent with disclosed embodiments. Non-transitory computer readable medium 1020 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1008 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1020, instructions and/or data may be provided as signals on transmission media included in a communication apparatus. For example, a communication apparatus may include an external interface including one or more of wireless transceivers 1010, 1011, 1012, and 1013 having signals indicative of instructions and data. The instructions and data are configured to cause one or more processors to implement the functions outlined in the claims. That is, the communication apparatus includes transmission media with signals indicative of information to perform disclosed functions.

Memory 1004 may represent any data storage mechanism. Memory 1004 may include, for example, a primary memory and/or a secondary memory. Primary memory may include, for example, a random access memory, read only memory, etc. While illustrated in this example as being separate from one or more processors 1002, it should be understood that all or part of a primary memory may be provided within or otherwise co-located/coupled with the one or more processors 1002. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1020. As such, in certain example implementations, the methods and/or apparatuses presented herein may take the form in whole or part of a computer readable medium 1020 that may include computer implementable program code 1008 stored thereon, which if executed by one or more processors 1002 may be operatively enabled to perform all or portions of the example operations as described herein. Computer readable medium 1020 may be a part of memory 1004.

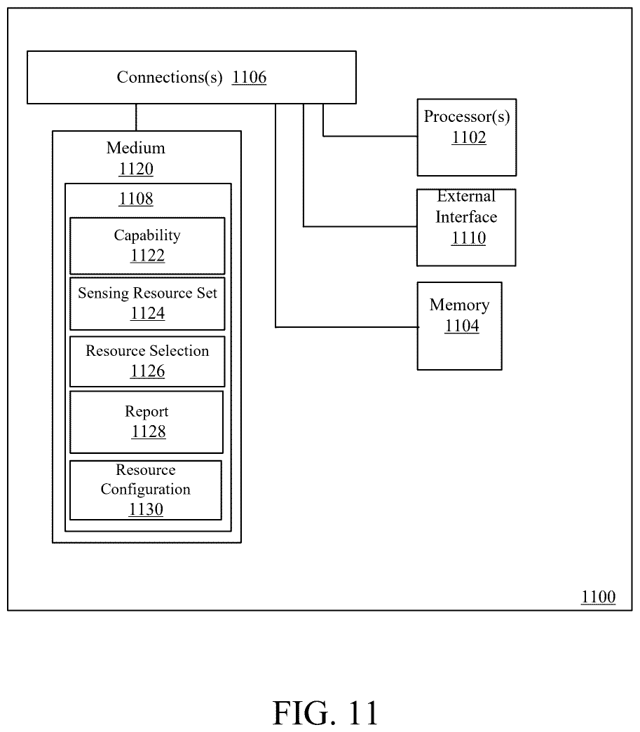

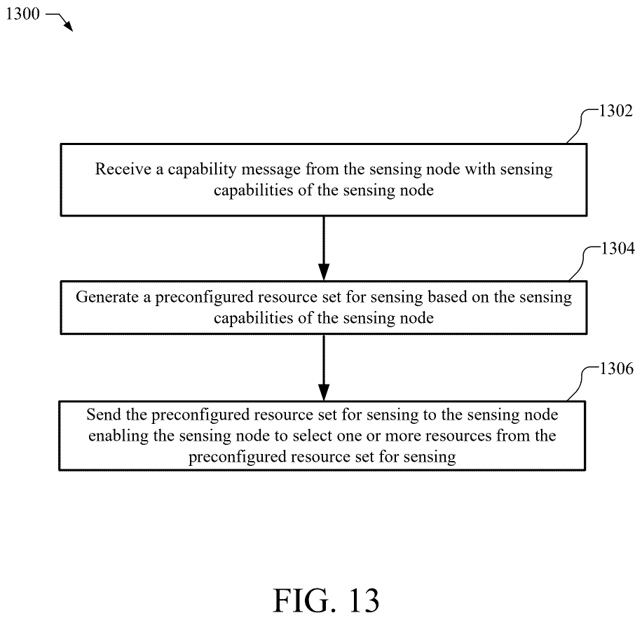

FIG. 11 shows a schematic block diagram illustrating certain exemplary features of a network node 1100, e.g., which may be, e.g., the sensing server 172 in FIG. 1, or network nodes 602, 802, or 902 in FIGS. 6, 8A-8D, 9, or 11, respectively, and supports sensing by a sensing node, such as a UE or base station, using a preconfigured resource set in a wireless network, as described herein. The network node 1100, for example, may perform the message flows 600, 800, 820, 840, 860, and 900, shown in FIGS. 6, 8A-8D, and 9, and the process flow 1300 shown in FIG. 13 and accompanying techniques as discussed herein. The network node 1100 may include, for example, one or more processors 1102 and memory 1104, an external interface 1110, which may be operatively coupled with one or more connections 1106 (e.g., buses, lines, fibers, links, etc.) to non-transitory computer readable medium 1120 and memory 1104. The external interface 1110 may be a wired and/or wireless interface capable of connecting to network entities in the core network 170, through which the network node 1100 may communicate sensing nodes, such as UEs or base stations, or if the network node is, e.g., a base station, the external interface 1110 may be wireless transceiver configured to communicate signals (e.g., with sensing nodes) according to a variety of radio access technologies (RATs). The network node 1100 may further include additional items, which are not shown, such as a user interface that may include e.g., a display, a keypad or other input device, such as virtual keypad on the display, through which a user may interface with the network node. In certain example implementations, all or part of network node 1100 may take the form of a chipset, and/or the like.

The one or more processors 1102 may be implemented using a combination of hardware, firmware, and software. For example, the one or more processors 1102 may be configured to perform the functions discussed herein by implementing one or more instructions or program code 1108 on a non-transitory computer readable medium, such as medium 1120 and/or memory 1104. In some embodiments, the one or more processors 1102 may represent one or more circuits configurable to perform at least a portion of a data signal computing procedure or process related to the operation of network node 1100.

The medium 1120 and/or memory 1104 may store instructions or program code 1108 that contain executable code or software instructions that when executed by the one or more processors 1102 cause the one or more processors 1102 to operate as a special purpose computer programmed to perform the techniques disclosed herein. As illustrated in network node 1100, the medium 1120 and/or memory 1104 may include one or more components or modules that may be implemented by the one or more processors 1102 to perform the methodologies described herein. While the components or modules are illustrated as software in medium 1120 that is executable by the one or more processors 1102, it should be understood that the components or modules may be stored in memory 1104 or may be dedicated hardware either in the one or more processors 1102 or off the processors.

A number of software modules and data tables may reside in the medium 1120 and/or memory 1104 and be utilized by the one or more processors 1102 in order to manage both communications and the functionality described herein. It should be appreciated that the organization of the contents of the medium 1120 and/or memory 1104 as shown in network node 1100 is merely exemplary, and as such the functionality of the modules and/or data structures may be combined, separated, and/or be structured in different ways depending upon the implementation of the network node 1100.

The medium 1120 and/or memory 1104 may include capability module 1122 that when implemented by the one or more processors 1102 configures the one or more processors 1102 to receive, via the external interface 1110, a capability message from the sensing node with sensing capabilities of the sensing node.

The medium 1120 and/or memory 1104 may include a sensing resource set module 1124 that when implemented by the one or more processors 1102 configures the one or more processors 1102 to configure a sensing resource set for the sensing node and to send to the sensing node, via the external interface 1110, the preconfigured resource set for sensing. The sensing resource set may be configured, for example, based on the capabilities of the sensing node. In some implementations, the sensing resource set may be configured, for example, based on a report received from the sensing node of resources that are not available due to interference and/or the level of interference on resources.

The medium 1120 and/or memory 1104 may include a resource selection module 1126 that when implemented by the one or more processors 1102 configures the one or more processors 1102 to send, via the external interface 1110, to a sensing node one or more interference thresholds to enable the sensing node to determine interference of resources in the preconfigured resource set. The one or more processors 1102 may be configured to send, via the external interface 1110, to a sensing node a time window to enable the sensing node to wait until the time window expires before determining if a resource continues to have interference after the resource is determined to have interference.

The medium 1120 and/or memory 1104 may include a report module 1128 that when implemented by the one or more processors 1102 configures the one or more processors 1102 to receive, via the external interface 1110, a report from the sensing node based on the interference of resources, e.g., as discussed in FIGS. 8A-8D and FIG. 9.

The medium 1120 and/or memory 1104 may include a resource configuration module 1130 that when implemented by the one or more processors 1102 configures the one or more processors 1102 to send, via the external interface 1110, to a second sensing node, an indication, e.g., the configuration, of one or more resources selected by a first sensing node for sensing so that the second sensing node can receive the one or more resources transmitted by the first sensing node.

The methodologies described herein may be implemented by various means depending upon the application. For example, these methodologies may be implemented in hardware, firmware, software, or any combination thereof. For a hardware implementation, the one or more processors 1102 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1120 or memory 1104 that is connected to and executed by the one or more processors 1102. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1108 on a non-transitory computer readable medium, such as medium 1120 and/or memory 1104. Examples include computer readable media encoded with a data structure and computer readable media encoded with a computer program code 1108. For example, the non-transitory computer readable medium including program code 1108 stored thereon may include program code 1108 to support sensing by a sensing node in a wireless network using a preconfigured resource set in a manner consistent with disclosed embodiments. Non-transitory computer readable medium 1120 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1108 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 1120, instructions and/or data may be provided as signals on transmission media included in a communication apparatus. For example, a communication apparatus may include the external interface 1110 having signals indicative of instructions and data. The instructions and data are configured to cause one or more processors to implement the functions outlined in the claims. That is, the communication apparatus includes transmission media with signals indicative of information to perform disclosed functions.

Memory 1104 may represent any data storage mechanism. Memory 1104 may include, for example, a primary memory and/or a secondary memory. Primary memory may include, for example, a random access memory, read only memory, etc. While illustrated in this example as being separate from one or more processors 1102, it should be understood that all or part of a primary memory may be provided within or otherwise co-located/coupled with the one or more processors 1102. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1120. As such, in certain example implementations, the methods and/or apparatuses presented herein may take the form in whole or part of a computer readable medium 1120 that may include computer implementable program code 1108 stored thereon, which if executed by one or more processors 1102 may be operatively enabled to perform all or portions of the example operations as described herein. Computer readable medium 1120 may be a part of memory 1104.

FIG. 12 is a flow chart illustrating a method 1200 for supporting radio frequency (RF) sensing in the wireless network, performed by a sensing node, such as UE 104, or base station 102, or sensing node 1000, as described herein.

At block 1202, the sensing node receives from a network node a preconfigured resource set for sensing, e.g., as described in stage 1 of FIG. 6 and stage 1 of FIG. 9. A means for receiving from a network node a preconfigured resource set for sensing may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the sensor resource set module 1022, shown in FIG. 10.

At block 1204, the sensing node selects one or more resources from the preconfigured resource set for sensing, e.g., as described in stage 3 of FIG. 6, stage 1 of FIGS. 8A-8D, and stages 3 and 4 of FIG. 9. A means for selecting one or more resources from the preconfigured resource set for sensing may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

At block 1206, the sensing node transmits the one or more resources for sensing, e.g., as discussed in stage 4 of FIG. 6, stage 2 of FIG. 8A, stage 3 of FIG. 8C, and stage 4 of FIG. 8D. A means for transmitting the one or more resources for sensing may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the sensing module 1026, shown in FIG. 10.

In one implementation, the sensing node may receive a sensing service request, wherein the one or more resources are selected from the preconfigured resource set for sensing in response to the sensing service request, e.g., as discussed in stage 2 of FIG. 6. A means for receiving a sensing service request, wherein the one or more resources are selected from the preconfigured resource set for sensing in response to the sensing service request may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the sensing module 1026, shown in FIG. 10.

In one implementation, the sensing node may send a capability message to the network node with a sensing capability, wherein the preconfigured resource set is based on the sensing capability, e.g., as discussed in stage 0 of FIG. 6. A means for sending a capability message to the network node with a sensing capability, wherein the preconfigured resource set is based on the sensing capability may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the capability module 1028, shown in FIG. 10.

In some implementations, the sensing node may select the one or more resources from the preconfigured resource set for sensing by measuring interference of resources from the preconfigured resource set, e.g., as described in stage 3 of FIG. 6, stage 1 of FIGS. 8A-8D, and stage 3 of FIG. 9. The sensing node may select the one or more resources without interference for sensing, e.g., as described in stage 3 of FIG. 6, stage 1 of FIGS. 8A-8D, and stage 4 of FIG. 9. A means for measuring interference of resources from the preconfigured resource set may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10. A means for selecting the one or more resources without interference for sensing may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

For example, in one implementation, the sensing node may measure the interference of the resources from the preconfigured resource set by determining a received signal strength of the resources, and may select the one or more resources without interference for sensing based on the received signal strength, e.g., as described in stage 3 of FIG. 6, stage 1 of FIGS. 8A-8D, and stage 3 of FIG. 9. A means for determining a received signal strength of the resources may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

In some implementations, the interference of the resources is measured for each of the resources sequentially or simultaneously

In some implementations, the sensing node may obtain at least one interference threshold, wherein the interference of the resources in the preconfigured resource set is determined based on the at least one interference threshold, e.g., as described in stage 3 of FIG. 6, stage 1 of FIGS. 8A-8D, and stage 3 of FIG. 9. In one implementation, one interference threshold is for all resources in the preconfigured resource set. In one implementation, different interference thresholds are for different resources in the preconfigured resource set. In one implementation, the at least one interference threshold is received from the network node. In one implementation, the at least one interference threshold is preconfigured and stored on the sensing node. In one implementation, different interference thresholds are configured for different use cases. A means for obtaining at least one interference threshold, wherein the interference of the resources in the preconfigured resource set is determined based on the at least one interference threshold may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

In one implementation, the sensing node receives a time window, wherein the sensing node selects the one or more resources from the preconfigured resource set by determining a resource has interference; and waiting until the time window expires before determining if the resource continues to have interference, e.g., as discussed in reference to FIG. 7, and stages 5 and 6 of FIG. 9. A means for receiving a time window may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10. A means for determining a resource has interference and means for waiting until the time window expires before determining if the resource continues to have interference may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

For example, in some implementations, the sensing node determines all resources in the preconfigured resource set have interference and waits until the time window expires before remeasuring the interference of the resources from the preconfigured resource set, e.g., as discussed in reference to FIG. 7, and stages 5 and 6 of FIG. 9. A means for determining all resources in the preconfigured resource set have interference and waiting until the time window expires before remeasuring the interference of the resources from the preconfigured resource set may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

For example, in some implementations, the sensing node increases the time window after each instance of determining that all resources in the preconfigured resource set have interference, e.g., as discussed in reference to FIG. 7, and stages 5 and 6 of FIG. 9. A means for increasing the time window after each instance of determining that all resources in the preconfigured resource set have interference may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

In some implementations, the sensing node is configured with a maximum time window or a maximum number of attempts to select a resource without interference, wherein the sensing node is configured to send a failure message to the network node or enters an idle mode if the maximum time window or the maximum number of attempts is reached, e.g., as discussed in FIG. 9 including stage 9 of FIG. 9.

In some implementations, the sensing node selects the one or more resources from the preconfigured resource set by selecting a first resource in the preconfigured resource set, and selecting a second resource in the preconfigured resource set if the first resource has interference, e.g., as discussed in stage 3 of FIG. 6 and FIG. 7. A means for selecting a first resource in the preconfigured resource set and selecting a second resource in the preconfigured resource set if the first resource has interference may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the resource selection module 1024, shown in FIG. 10.

In one implementation, the sensing node sends a report to the network node based on the interference of resources, e.g., as discussed in stage 3 of FIG. 8A, stage 2 of FIGS. 8B, 8C, and 8D, and stage 9 of FIG. 9. A means for sending a report to the network node based on the interference of resources may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the report module 1030, shown in FIG. 10.

In one example, the sensing node may send periodical reports, wherein each of the periodical reports includes information for all resources in the preconfigured resource set or for only resources with interference or for only resources without interference, e.g., as discussed in stage 3 of FIG. 8A.

In one example, the sensing node receives a second preconfigured resource set before receiving the preconfigured resource set, e.g., as discussed in stage 1 of FIG. 6 and stage 1 of FIG. 8B, wherein the report is sent in response to determining all resources in the second preconfigured resource set have interference, e.g., as discussed in stage 2 of FIG. 8B, and the sensing node receives the preconfigured resource set in response to the report, e.g., as discussed in stage 3 of FIG. 8B. The report may indicate that each resource is not available due to interference or indicate an amount of interference for each resource. A means for receiving a second preconfigured resource set before receiving the preconfigured resource set, wherein sending the report is in response to determining all resources in the second preconfigured resource set have interference may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the sensor resource set module 1022, shown in FIG. 10. A means for receiving the preconfigured resource set in response to the report may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the sensor resource set module 1022, shown in FIG. 10.

In one example, the report indicates the one or more resources selected for sensing, e.g., as discussed in stage 2 of FIG. 8C. The sensing node may send an indication to the network node when the sensing node releases the one or more resources, e.g., as discussed in stage 4 of FIG. 8C. A means for sending an indication to the network node when the sensing node releases the one or more resources may include the external interface including one or more of wireless transceivers 1010, 1011, 1012, and 1013, along with one or more processors 1002 with dedicated hardware or implementing executable code or software instructions in memory 1004 and/or medium 1020 in sensing node 1000, such as the report module 1030, shown in FIG. 10.

In one example, the report indicates the one or more resources selected for sensing to enable the network node to indicate the one or more resources selected for sensing to a second sensing node for reception of the one or more resources transmitted by the sensing node, e.g., as discussed in stages 2 and 3 of FIG. 8D.

FIG. 13 is a flow chart illustrating a method 1300 performed by a network node in a wireless network, such as sensing server 172 in FIG. 1, or network nodes 602, 802, 902, or 1100 in FIGS. 6, 8A-8D, 9, or 11, respectively, for supporting radio frequency (RF) sensing by a sensing node, such UE 104 or base station 102, in the wireless network, as described herein.

At block 1302, the network node receives a capability message from the sensing node with sensing capabilities of the sensing node, e.g., as described in stage 0 of FIG. 6. A means for receiving a capability message from the sensing node with sensing capabilities of the sensing node may include the external interface 1110, along with one or more processors 1102 with dedicated hardware or implementing executable code or software instructions in memory 1104 and/or medium 1120 in network node 1100, such as the capability module 1122, shown in FIG. 11.

At block 1304, the network node generates a preconfigured resource set for sensing based on the sensing capabilities of the sensing node, e.g., as described in stage 1 of FIG. 6 and stage 1 of FIG. 9. A means for generating a preconfigured resource set for sensing based on the sensing capabilities of the sensing node may include the external interface 1110, along with one or more processors 1102 with dedicated hardware or implementing executable code or software instructions in memory 1104 and/or medium 1120 in network node 1100, such as the sensing resource set module 1124, shown in FIG. 11.

At block 1306, the network node sends the preconfigured resource set for sensing to the sensing node enabling the sensing node to select one or more resources from the preconfigured resource set for sensing, e.g., as described in stage 1 of FIG. 6 and stage 1 of FIG. 9. A means for sending the preconfigured resource set for sensing to the sensing node enabling the sensing node to select one or more resources from the preconfigured resource set for sensing may include the external interface 1110, along with one or more processors 1102 with dedicated hardware or implementing executable code or software instructions in memory 1104 and/or medium 1120 in network node 1100, such as the sensing resource set module 1124, shown in FIG. 11.

In some implementations, the sensing node is enabled to select the one or more resources from the preconfigured resource set for sensing based on measured interference of resources from the preconfigured resource set, e.g., as described in stage 3 of FIG. 6, stage 1 of FIGS. 8A-8D, and stage 3 of FIG. 9.

In some implementations, the network node sends at least one interference threshold to the sensing node to enable the sensing node to determine interference of resources from the preconfigured resource set based on the at least one interference threshold, e.g., as described in stage 3 of FIG. 6, stage 1 of FIGS. 8A-8D, and stage 3 of FIG. 9. In one implementation, one interference threshold is for all resources in the preconfigured resource set. In one implementation, different interference thresholds are for different resources in the preconfigured resource set. A means for sending at least one interference threshold to the sensing node to enable the sensing node to determine interference of resources from the preconfigured resource set based on the at least one interference threshold may include the external interface 1110, along with one or more processors 1102 with dedicated hardware or implementing executable code or software instructions in memory 1104 and/or medium 1120 in network node 1100, such as the resource selection module 1126, shown in FIG. 11.

In one implementation, the network node sending a time window to the sensing node to enable the sensing node to wait until the time window expires before determining if a resource continues to have interference after the resource is determined to have interference, e.g., as discussed in reference to FIG. 7, and stages 5 and 6 of FIG. 9. A means for sending a time window to the sensing node to enable the sensing node to wait until the time window expires before determining if a resource continues to have interference after the resource is determined to have interference may include the external interface 1110, along with one or more processors 1102 with dedicated hardware or implementing executable code or software instructions in memory 1104 and/or medium 1120 in network node 1100, such as the resource selection module 1126, shown in FIG. 11.

In one implementation, the network node receives a report from the sensing node indicating that all resources have interference after multiple attempts to select a resource without interference, e.g., as discussed in stage 3 of FIG. 8A, stage 2 of FIGS. 8B, 8C, and 8D, and stage 9 of FIG. 9. A means for receiving a report from the sensing node indicating that all resources have interference after multiple attempts to select a resource without interference may include the external interface 1110, along with one or more processors 1102 with dedicated hardware or implementing executable code or software instructions in memory 1104 and/or medium 1120 in network node 1100, such as the report module 1128, shown in FIG. 11.

In one implementation, the network node receives a report from the sensing node based on the interference of resources, e.g., as discussed in stage 3 of FIG. 8A, stage 2 of FIGS. 8B, 8C, and 8D, and stage 9 of FIG. 9. A means for receiving a report from the sensing node based on the interference of resources may include the external interface 1110, along with one or more processors 1102 with dedicated hardware or implementing executable code or software instructions in memory 1104 and/or medium 1120 in network node 1100, such as the report module 1128, shown in FIG. 11.

In one example, the network node may receive periodical reports, wherein each of the periodical reports includes information for all resources in the preconfigured resource set or for only resources with interference or for only resources without interference, e.g., as discussed in stage 3 of FIG. 8A.

In one example, the report indicates that all resources in the preconfigured resource set have interference, e.g., as discussed in stage 2 of FIG. 8B, and the network node generates a second preconfigured resource set for sensing based on the sensing capabilities of the sensing node and the report and sends the second preconfigured resource set for sensing to the sensing node, e.g., as discussed in stage 3 of FIG. 8B. The report may indicate that each resource is not available due to interference or indicate an amount of interference for each resource. A means for generating a second preconfigured resource set for sensing based on the sensing capabilities of the sensing node and the report and sending the second preconfigured resource set for sensing to the sensing node may include the external interface 1110, along with one or more processors 1102 with dedicated hardware or implementing executable code or software instructions in memory 1104 and/or medium 1120 in network node 1100, such as the sensing resource set module 1124, shown in FIG. 11.

In one example, the report indicates one or more resources selected by the sensing node for sensing, e.g., as discussed in stage 2 of FIG. 8C, and the network node receives an indication from the sensing node when the sensing node releases the one or more resources, e.g., as discussed in stage 4 of FIG. 8C. A means for receiving an indication from the sensing node when the sensing node releases the one or more resources may include the external interface 1110, along with one or more processors 1102 with dedicated hardware or implementing executable code or software instructions in memory 1104 and/or medium 1120 in network node 1100, such as the report module 1128, shown in FIG. 11.

In one example, the report indicates one or more resources selected for sensing, e.g., as discussed in stage 2 of FIG. 8D, and the network node sends an indication of the one or more resources selected by the sensing node for sensing to a second sensing node for reception of the one or more resources transmitted by the sensing node, e.g., as discussed in stage 3 of FIG. 8D. The report indicates one or more resources selected for sensing with a resource index, and the indication of the one or more resources selected by the sensing node sent to the second sensing node configures each of the one or more resources, e.g., as discussed in stages 2 and 3 of FIG. 8D. A means for sending an indication of the one or more resources selected by the sensing node for sensing to a second sensing node for reception of the one or more resources transmitted by the sensing node may include the external interface 1110, along with one or more processors 1102 with dedicated hardware or implementing executable code or software instructions in memory 1104 and/or medium 1120 in network node 1100, such as the resource configuration module 1130, shown in FIG. 11.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

In view of this description embodiments may include different combinations of features. Implementation examples are described in the following numbered clauses:

Clause 1. A method performed by a sensing node in a wireless network for supporting radio frequency (RF) sensing in the wireless network, comprising: receiving from a network node a preconfigured resource set for sensing; selecting one or more resources from the preconfigured resource set for sensing; and transmitting the one or more resources for sensing.

Clause 2. The method of clause 1, further comprising receiving a sensing service request, wherein the one or more resources are selected from the preconfigured resource set for sensing in response to the sensing service request.

Clause 3. The method of any of clauses 1-2, further comprising sending a capability message to the network node with a sensing capability, wherein the preconfigured resource set is based on the sensing capability.

Clause 4. The method of any of clauses 1-3, wherein selecting the one or more resources from the preconfigured resource set for sensing comprises: measuring interference of resources from the preconfigured resource set; and selecting the one or more resources without interference for sensing.

Clause 5. The method of clause 4, wherein measuring the interference of the resources from the preconfigured resource set comprises determining a received signal strength of the resources, and wherein selecting the one or more resources without interference for sensing is based on the received signal strength.

Clause 6. The method of any of clauses 4-5, wherein the interference of the resources is measured for each of the resources sequentially or simultaneously.

Clause 7. The method of any of clauses 4-6, further obtaining at least one interference threshold, wherein the interference of the resources in the preconfigured resource set is determined based on the at least one interference threshold.

Clause 8. The method of clause 7, wherein one interference threshold is for all resources in the preconfigured resource set.

Clause 9. The method of any of clauses 7-8, wherein different interference thresholds are for different resources in the preconfigured resource set.

Clause 10. The method of any of clauses 7-9, wherein the at least one interference threshold is received from the network node.

Clause 11. The method of any of clauses 7-9, wherein the at least one interference threshold is preconfigured and stored on the sensing node.

Clause 12. The method of any of clauses 7-11, wherein different interference thresholds are configured for different use cases.

Clause 13. The method of any of clauses 4-12, further comprising receiving a time window, wherein selecting the one or more resources from the preconfigured resource set comprises: determining a resource has interference; and waiting until the time window expires before determining if the resource continues to have interference.

Clause 14. The method of clause 13, further comprising determining all resources in the preconfigured resource set have interference and waiting until the time window expires before remeasuring the interference of the resources from the preconfigured resource set.

Clause 15. The method of clause 14, further comprising increasing the time window after each instance of determining that all resources in the preconfigured resource set have interference.

Clause 16. The method of clause 15, wherein the sensing node is configured with a maximum time window or a maximum number of attempts to select a resource without interference, wherein the sensing node is configured to send a failure message to the network node or enters an idle mode if the maximum time window or the maximum number of attempts is reached.

Clause 17. The method of any of clauses 4-16, wherein selecting the one or more resources from the preconfigured resource set comprises: selecting a first resource in the preconfigured resource set; and selecting a second resource in the preconfigured resource set if the first resource has interference.

Clause 18. The method of any of clauses 4-17, further comprising sending a report to the network node based on the interference of resources.

Clause 19. The method of clause 18, wherein sending the report comprises sending periodical reports, wherein each of the periodical reports includes information for all resources in the preconfigured resource set or for only resources with interference or for only resources without interference.

Clause 20. The method of any of clauses 18-19, further comprising: receiving a second preconfigured resource set before receiving the preconfigured resource set, wherein sending the report is in response to determining all resources in the second preconfigured resource set have interference; and receiving the preconfigured resource set in response to the report.

Clause 21. The method of clause 20, wherein the report indicates that each resource is not available due to interference or indicates an amount of interference for each resource.

Clause 22. The method of any of clauses 18-21, wherein the report indicates the one or more resources selected for sensing, the method further comprising sending an indication to the network node when the sensing node releases the one or more resources.

Clause 23. The method of any of clauses 18-22, wherein the report indicates the one or more resources selected for sensing to enable the network node to indicate the one or more resources selected for sensing to a second sensing node for reception of the one or more resources transmitted by the sensing node.

Clause 24. The method of any of clauses 1-23, wherein the sensing node comprises one of a user equipment (UE) or a base station.

Clause 25. A sensing node in a wireless network configured for supporting radio frequency (RF) sensing in the wireless network, comprising: at least one wireless transceiver; at least one memory; and at least one processor coupled to the at least one wireless transceiver and the at least one memory, wherein the at least one processor is configured to cause the network node to: receive, via the at least one wireless transceiver, from a network node a preconfigured resource set for sensing; select one or more resources from the preconfigured resource set for sensing; and transmit, via the at least one wireless transceiver, the one or more resources for sensing.

Clause 26. The sensing node of clause 25, wherein the at least one processor is further configured to receive, via the at least one wireless transceiver, a sensing service request, wherein the one or more resources are selected from the preconfigured resource set for sensing in response to the sensing service request.

Clause 27. The sensing node of any of clauses 25-26, wherein the at least one processor is further configured to send, via the at least one wireless transceiver, a capability message to the network node with a sensing capability, wherein the preconfigured resource set is based on the sensing capability.

Clause 28. The sensing node of any of clauses 25-27, wherein the at least one processor is configured to select the one or more resources from the preconfigured resource set for sensing by being configured to: measure interference of resources from the preconfigured resource set; and select the one or more resources without interference for sensing.

Clause 29. The sensing node of clause 28, wherein the at least one processor is configured to measure the interference of the resources from the preconfigured resource set comprises determining a received signal strength of the resources, and wherein selecting the one or more resources without interference for sensing is based on the received signal strength.

Clause 30. The sensing node of any of clauses 28-29, wherein the interference of the resources is measured for each of the resources sequentially or simultaneously.

Clause 31. The sensing node of any of clauses 28-30, wherein the at least one processor is further configured to obtain at least one interference threshold, wherein the interference of the resources in the preconfigured resource set is determined based on the at least one interference threshold.

Clause 32. The sensing node of clause 31, wherein one interference threshold is for all resources in the preconfigured resource set.

Clause 33. The sensing node of any of clauses 31-32, wherein different interference thresholds are for different resources in the preconfigured resource set.

Clause 34. The sensing node of any of clauses 31-33, wherein the at least one interference threshold is received from the network node.

Clause 35. The sensing node of any of clauses 31-33, wherein the at least one interference threshold is preconfigured and stored on the sensing node.

Clause 36. The sensing node of any of clauses 31-35, wherein different interference thresholds are configured for different use cases.

Clause 37. The sensing node of any of clauses 28-36, wherein the at least one processor is further configured to receive, via the at least one wireless transceiver, a time window, wherein the at least one processor is configured to select the one or more resources from the preconfigured resource set by being configured to: determine a resource has interference; and wait until the time window expires before determining if the resource continues to have interference.

Clause 38. The sensing node of clause 37, wherein the at least one processor is further configured to determine all resources in the preconfigured resource set have interference and wait until the time window expires before remeasuring the interference of the resources from the preconfigured resource set.

Clause 39. The sensing node of clause 38, wherein the at least one processor is further configured to increase the time window after each instance of determining that all resources in the preconfigured resource set have interference.

Clause 40. The sensing node of clause 39, wherein the sensing node is configured with a maximum time window or a maximum number of attempts to select a resource without interference, wherein the sensing node is configured to send a failure message to the network node or enters an idle mode if the maximum time window or the maximum number of attempts is reached.

Clause 41. The sensing node of any of clauses 28-40, wherein the at least one processor is configured to select the one or more resources from the preconfigured resource set by being configured to: select a first resource in the preconfigured resource set; and select a second resource in the preconfigured resource set if the first resource has interference.

Clause 42. The sensing node of any of clauses 28-41, wherein the at least one processor is further configured to send a report to the network node based on the interference of resources.

Clause 43. The sensing node of clause 42, wherein the at least one processor is configured to send the report by being configured to send, via the at least one wireless transceiver, periodical reports, wherein each of the periodical reports includes information for all resources in the preconfigured resource set or for only resources with interference or for only resources without interference.

Clause 44. The sensing node of any of clauses 42-43, wherein the at least one processor is further configured to: receive, via the at least one wireless transceiver, a second preconfigured resource set before receiving the preconfigured resource set, wherein sending the report is in response to determining all resources in the second preconfigured resource set have interference; and receive, via the at least one wireless transceiver, the preconfigured resource set in response to the report.

Clause 45. The sensing node of clause 44, wherein the report indicates that each resource is not available due to interference or indicates an amount of interference for each resource.

Clause 46. The sensing node of any of clauses 42-45, wherein the report indicates the one or more resources selected for sensing, the method further comprising sending an indication to the network node when the sensing node releases the one or more resources.

Clause 47. The sensing node of any of clauses 42-46, wherein the report indicates the one or more resources selected for sensing to enable the network node to indicate the one or more resources selected for sensing to a second sensing node for reception of the one or more resources transmitted by the sensing node.

Clause 48. The sensing node of any of clauses 25-47, wherein the sensing node comprises one of a user equipment (UE) or a base station.

Clause 49. A sensing node in a wireless network configured for supporting radio frequency (RF) sensing in the wireless network, comprising: means for receiving from a network node a preconfigured resource set for sensing; means for selecting one or more resources from the preconfigured resource set for sensing; and means for transmitting the one or more resources for sensing.

Clause 50. A non-transitory storage medium including program code stored thereon, the program code is operable to configure at least one processor in a sensing node in a wireless network for supporting radio frequency (RF) sensing in the wireless network, the program code comprising instructions to: receive from a network node a preconfigured resource set for sensing; select one or more resources from the preconfigured resource set for sensing; and transmit the one or more resources for sensing.

Clause 51. A method performed by a network node in a wireless network for supporting radio frequency (RF) sensing by a sensing node in the wireless network, comprising: receiving a capability message from the sensing node with sensing capabilities of the sensing node; generating a preconfigured resource set for sensing based on the sensing capabilities of the sensing node; and sending the preconfigured resource set for sensing to the sensing node enabling the sensing node to select one or more resources from the preconfigured resource set for sensing.

Clause 52. The method of clause 51, wherein the sensing node is enabled to select the one or more resources from the preconfigured resource set for sensing based on measured interference of resources from the preconfigured resource set.

Clause 53. The method of clause 52, further comprising sending at least one interference threshold to the sensing node to enable the sensing node to determine interference of resources from the preconfigured resource set based on the at least one interference threshold.

Clause 54. The method of clause 53, wherein one interference threshold is for all resources in the preconfigured resource set.

Clause 55. The method of clause 53, wherein different interference thresholds are for different resources in the preconfigured resource set.

Clause 56. The method of any of clauses 52-55, further comprising sending a time window to the sensing node to enable the sensing node to wait until the time window expires before determining if a resource continues to have interference after the resource is determined to have interference.

Clause 57. The method of clause 56, further comprising receiving a report from the sensing node indicating that all resources have interference after multiple attempts to select a resource without interference.

Clause 58. The method of any of clauses 52-57, further comprising receiving a report from the sensing node based on the interference of resources.

Clause 59. The method of clause 58, wherein receiving the report comprises receiving periodical reports, wherein each of the periodical reports includes information for all resources in the preconfigured resource set or for only resources with interference or for only resources without interference.

Clause 60. The method of clause 58, wherein the report indicates that all resources in the preconfigured resource set have interference, the method further comprising: generating a second preconfigured resource set for sensing based on the sensing capabilities of the sensing node and the report; and sending the second preconfigured resource set for sensing to the sensing node.

Clause 61. The method of clause 60, wherein the report indicates that each resource is not available due to interference or indicates an amount of interference for each resource.

Clause 62. The method of any of clauses 58, wherein the report indicates one or more resources selected by the sensing node for sensing, the method further comprising receiving an indication from the sensing node when the sensing node releases the one or more resources.

Clause 63. The method of any of clauses 58-62, wherein the report indicates one or more resources selected for sensing, the method further comprising sending an indication of the one or more resources selected by the sensing node for sensing to a second sensing node for reception of the one or more resources transmitted by the sensing node.

Clause 64. The method of clause 63, wherein the report indicates one or more resources selected for sensing with a resource index, and wherein the indication of the one or more resources selected by the sensing node sent to the second sensing node configures each of the one or more resources.

Clause 65. A network node in a wireless network configured for supporting radio frequency (RF) sensing by a sensing node in the wireless network, comprising: an external interface; at least one memory; and at least one processor coupled to the external interface and the at least one memory, wherein the at least one processor is configured to cause the network node to: receive, via the external interface, a capability message from the sensing node with sensing capabilities of the sensing node; generate a preconfigured resource set for sensing based on the sensing capabilities of the sensing node; and send, via the external interface, the preconfigured resource set for sensing to the sensing node enabling the sensing node to select one or more resources from the preconfigured resource set for sensing.

Clause 66. The network node of clause 65, wherein the sensing node is enabled to select the one or more resources from the preconfigured resource set for sensing based on measured interference of resources from the preconfigured resource set.

Clause 67. The network node of clause 66, wherein the at least one processor is further configured to send, via the external interface, at least one interference threshold to the sensing node to enable the sensing node to determine interference of resources from the preconfigured resource set based on the at least one interference threshold.

Clause 68. The network node of clause 67, wherein one interference threshold is for all resources in the preconfigured resource set.

Clause 69. The network node of clause 67, wherein different interference thresholds are for different resources in the preconfigured resource set.

Clause 70. The network node of any of clauses 66-69, wherein the at least one processor is further configured to send, via the external interface, a time window to the sensing node to enable the sensing node to wait until the time window expires before determining if a resource continues to have interference after the resource is determined to have interference.

Clause 71. The network node of clause 70, wherein the at least one processor is further configured to receive, via the external interface, a report from the sensing node indicating that all resources have interference after multiple attempts to select a resource without interference.

Clause 72. The network node of any of clauses 66-71, wherein the at least one processor is further configured to receive, via the external interface, a report from the sensing node based on the interference of resources.

Clause 73. The network node of clause 72, wherein the at least one processor is configured to receive the report by being configured to receive, via the external interface, periodical reports, wherein each of the periodical reports includes information for all resources in the preconfigured resource set or for only resources with interference or for only resources without interference.

Clause 74. The network node of clause 72, wherein the report indicates that all resources in the preconfigured resource set have interference, wherein the at least one processor is further configured to: generate a second preconfigured resource set for sensing based on the sensing capabilities of the sensing node and the report; and send, via the external interface, the second preconfigured resource set for sensing to the sensing node.

Clause 75. The network node of clause 74, wherein the report indicates that each resource is not available due to interference or indicates an amount of interference for each resource.

Clause 76. The network node of any of clauses 72-75, wherein the report indicates one or more resources selected by the sensing node for sensing, wherein the at least one processor is further configured to receive, via the external interface, an indication from the sensing node when the sensing node releases the one or more resources.

Clause 77. The network node of any of clauses 72-76, wherein the report indicates one or more resources selected for sensing, wherein the at least one processor is further configured to send, via the external interface, an indication of the one or more resources selected by the sensing node for sensing to a second sensing node for reception of the one or more resources transmitted by the sensing node.

Clause 78. The network node of clause 77, wherein the report indicates one or more resources selected for sensing with a resource index, and wherein the indication of the one or more resources selected by the sensing node sent to the second sensing node configures each of the one or more resources.

Clause 79. A network node in a wireless network configured for supporting radio frequency (RF) sensing by a sensing node in the wireless network, comprising: means for receiving a capability message from the sensing node with sensing capabilities of the sensing node; means for generating a preconfigured resource set for sensing based on the sensing capabilities of the sensing node; and means for sending the preconfigured resource set for sensing to the sensing node enabling the sensing node to select one or more resources from the preconfigured resource set for sensing.

Clause 80. A non-transitory storage medium including program code stored thereon, the program code is operable to configure at least one processor in a network node in a wireless network for supporting radio frequency (RF) sensing by a sensing node in the wireless network, the program code comprising instructions to: receive a capability message from the sensing node with sensing capabilities of the sensing node; generate a preconfigured resource set for sensing based on the sensing capabilities of the sensing node; and send the preconfigured resource set for sensing to the sensing node enabling the sensing node to select one or more resources from the preconfigured resource set for sensing.

Therefore, it is intended that claimed subject matter not be limited to the particular examples disclosed, but that such claimed subject matter may also include all aspects falling within the scope of appended claims, and equivalents thereof.

What is claimed is:

1. A method performed by a sensing node in a wireless network for supporting radio frequency (RF) sensing in the wireless network, comprising:
receiving from a network node a preconfigured resource set for sensing;
selecting one or more resources from the preconfigured resource set for sensing; and
transmitting the one or more resources for sensing.

2. The method of claim 1, further comprising receiving a sensing service request, wherein the one or more resources are selected from the preconfigured resource set for sensing in response to the sensing service request.

3. The method of claim 1, further comprising sending a capability message to the network node with a sensing capability, wherein the preconfigured resource set is based on the sensing capability.

4. The method of claim 1, wherein selecting the one or more resources from the preconfigured resource set for sensing comprises:
measuring interference of resources from the preconfigured resource set; and
selecting the one or more resources without interference for sensing.

5. The method of claim 4, wherein measuring the interference of the resources from the preconfigured resource set comprises determining a received signal strength of the resources, and wherein selecting the one or more resources without interference for sensing is based on the received signal strength.

6. The method of claim 4, wherein the interference of the resources is measured for each of the resources sequentially or simultaneously.

7. The method of claim 4, further obtaining at least one interference threshold, wherein the interference of the resources in the preconfigured resource set is determined based on the at least one interference threshold.

8. The method of claim 4, further comprising receiving a time window, wherein selecting the one or more resources from the preconfigured resource set comprises:
determining a resource has interference; and
waiting until the time window expires before determining if the resource continues to have interference.

9. The method of claim 4, wherein selecting the one or more resources from the preconfigured resource set comprises:
selecting a first resource in the preconfigured resource set; and
selecting a second resource in the preconfigured resource set if the first resource has interference.

10. The method of claim 4, further comprising sending a report to the network node based on the interference of resources.

11. A sensing node in a wireless network configured for supporting radio frequency (RF) sensing in the wireless network, comprising:
at least one wireless transceiver;
at least one memory; and
at least one processor coupled to the at least one wireless transceiver and the at least one memory, wherein the at least one processor is configured to cause the network node to:
receive, via the at least one wireless transceiver, from a network node a preconfigured resource set for sensing;
select one or more resources from the preconfigured resource set for sensing; and
transmit, via the at least one wireless transceiver, the one or more resources for sensing.

12. The sensing node of claim 11, wherein the at least one processor is further configured to receive, via the at least one wireless transceiver, a sensing service request, wherein the one or more resources are selected from the preconfigured resource set for sensing in response to the sensing service request.

13. The sensing node of claim 11, wherein the at least one processor is further configured to send, via the at least one wireless transceiver, a capability message to the network node with a sensing capability, wherein the preconfigured resource set is based on the sensing capability.

14. The sensing node of claim 11, wherein the at least one processor is configured to select the one or more resources from the preconfigured resource set for sensing by being configured to:
measure interference of resources from the preconfigured resource set; and
select the one or more resources without interference for sensing.

15. The sensing node of claim 14, wherein the at least one processor is configured to measure the interference of the resources from the preconfigured resource set comprises determining a received signal strength of the resources, and wherein selecting the one or more resources without interference for sensing is based on the received signal strength.

16. The sensing node of claim 14, wherein the interference of the resources is measured for each of the resources sequentially or simultaneously.

17. The sensing node of claim 14, wherein the at least one processor is further configured to obtain at least one interference threshold, wherein the interference of the resources in the preconfigured resource set is determined based on the at least one interference threshold.

18. The sensing node of claim 14, wherein the at least one processor is further configured to receive, via the at least one wireless transceiver, a time window, wherein the at least one processor is configured to select the one or more resources from the preconfigured resource set by being configured to:
determine a resource has interference; and
wait until the time window expires before determining if the resource continues to have interference.

19. The sensing node of claim 14, wherein the at least one processor is configured to select the one or more resources from the preconfigured resource set by being configured to:
select a first resource in the preconfigured resource set; and
select a second resource in the preconfigured resource set if the first resource has interference.

20. The sensing node of claim 14, wherein the at least one processor is further configured to send a report to the network node based on the interference of resources.

21. A method performed by a network node in a wireless network for supporting radio frequency (RF) sensing by a sensing node in the wireless network, comprising:
receiving a capability message from the sensing node with sensing capabilities of the sensing node;
generating a preconfigured resource set for sensing based on the sensing capabilities of the sensing node; and
sending the preconfigured resource set for sensing to the sensing node enabling the sensing node to select one or more resources from the preconfigured resource set for sensing.

22. The method of claim 21, wherein the sensing node is enabled to select the one or more resources from the preconfigured resource set for sensing based on measured interference of resources from the preconfigured resource set.

23. The method of claim 22, further comprising sending at least one interference threshold to the sensing node to enable the sensing node to determine interference of resources from the preconfigured resource set based on the at least one interference threshold.

24. The method of claim 22, further comprising sending a time window to the sensing node to enable the sensing node to wait until the time window expires before determining if a resource continues to have interference after the resource is determined to have interference.

25. The method of claim 22, further comprising receiving a report from the sensing node based on the interference of resources.

26. A network node in a wireless network configured for supporting radio frequency (RF) sensing by a sensing node in the wireless network, comprising:
an external interface;
at least one memory; and
at least one processor coupled to the external interface and the at least one memory, wherein the at least one processor is configured to cause the network node to:
receive, via the external interface, a capability message from the sensing node with sensing capabilities of the sensing node;
generate a preconfigured resource set for sensing based on the sensing capabilities of the sensing node; and
send, via the external interface, the preconfigured resource set for sensing to the sensing node enabling the sensing node to select one or more resources from the preconfigured resource set for sensing.

27. The network node of claim 26, wherein the sensing node is enabled to select the one or more resources from the preconfigured resource set for sensing based on measured interference of resources from the preconfigured resource set.

28. The network node of claim 27, wherein the at least one processor is further configured to send, via the external interface, at least one interference threshold to the sensing node to enable the sensing node to determine interference of resources from the preconfigured resource set based on the at least one interference threshold.

29. The network node of claim 27, wherein the at least one processor is further configured to send, via the external interface, a time window to the sensing node to enable the sensing node to wait until the time window expires before determining if a resource continues to have interference after the resource is determined to have interference.

30. The network node of claim 27, wherein the at least one processor is further configured to receive, via the external interface, a report from the sensing node based on the interference of resources.
